(19) United States
(12) Patent Application Publication
(10) Pub. No.: US 2023/0309567 A1
(43) Pub. Date: Oct. 5, 2023

(54) PESTICIDE PLUGS INCLUDING CELLULOSIC MATERIAL, AND RELATED METHODS

(71) Applicant: BOARD OF TRUSTEES OF MICHIGAN STATE UNIVERSITY, East Lansing, MI (US)

(72) Inventors: John C. Wise, Bath, MI (US); Christine Vandervoort, Williamston, MI (US); Annabel G. Wise, Bath, MI (US)

(21) Appl. No.: 18/022,586

(22) PCT Filed: Aug. 24, 2021
(86) PCT No.: PCT/US21/47230

§ 371 Date: Feb. 22, 2023

Related U.S. Application Data
(60) Provisional application No. 63/069,268, filed on Aug. 24, 2020.

(51) Int. Cl. A01N 63/60; A01N 25/10; A01P 7/04; A01P 7/02

(52) U.S. Cl. CPC A01N 63/60; A01N 25/10; A01P 7/04; A01P 7/02

(57) ABSTRACT

The disclosure relates to composite pesticide plugs for delivery of one or more dsRNA plant protection materials to internal tree tissue of, for example, fruit trees. The composite pesticide plugs generally include a cellulosic material, dsRNA (double-stranded RNA) bound to the cellulosic material, and, optionally, a thermoplastic polymer matrix. The disclosure also relates to methods of preparing the composite pesticide plugs, and methods for delivering a dsRNA plant protection material to trees. After injection into the tree trunk, the composite pesticide plug can provide a uniform, relatively consistent dose of dsRNA to all parts of the tree throughout the growing season, thus reducing waste of material and cost.

### CROSS REFERENCE TO RELATED APPLICATION

Priority is claimed to U.S. Provisional Application No. 63/069,268 filed on Aug. 24, 2020, which is incorporated herein by reference in its entirety.

### STATEMENT OF GOVERNMENT INTEREST

None.

### BACKGROUND OF THE DISCLOSURE

### Field of the Disclosure

The disclosure relates to pesticide plugs, in particular composite pesticide plugs, for delivery of one or more dsRNA plant protection materials to internal tree tissue. The disclosure also relates to methods of preparing the (composite) pesticide plugs and methods for delivering for a dsRNA plant protection material to a tree using the (composite pesticide) plugs.

### Brief Description of Related Technology

Tree fruit producers currently rely on airblast ground sprayers to deliver pesticides to their orchards in order to control insects and disease pests. However, these airblast sprayers typically provide only 29% to 56% of the applied spray solution to the tree canopy, while the remaining solution drifts to the ground or other off-target end points. Pest management inputs comprise about 30% or more of the total annual variable costs in fruit production, and they significantly influence marketable yield. Trunk injection represents an alternate technology for the delivery of pesticides to tree fruit crops. Arborists have developed a variety of techniques for injecting pesticides directly into tree trunks, which then can be translocated from the injection site to the canopy area of insect feeding or disease infection. This technology has been successfully used in protecting ash trees from the Emerald ash borer (EAB) in urban and suburban landscapes because of minimal risks of applicator exposure, drift and impacts on non-target organisms, and superior duration of control compared to foliar application.

The commercial ARBORJET QUIK-JET system relies upon drilling a hole in the trunk, and injecting a pesticide solution into the cavity, after which the xylem translocates the material to the tree canopy. The ARBORSYSTEMS WEDGLE drills a shallow hole into the tree trunk, and then makes a pressure injection of liquid solution into the cambial zone of the trunk. These types of injection techniques result in a temporally variable residue profile in the tree canopy, resulting in unnecessarily high doses of insecticide. Another trunk injection technology, the ACECAP Systemic Insecticide Tree Implant, inserts a capsule containing the pesticide into the tree trunk. After the pesticide is released, however, the capsule remains as a contaminant that hinders tree healing. Both of these commercial systems can cause unacceptable injury to the tree trunk, thus hindering potential adoption in the tree fruit industry. The commercial BITE-INFUSION system avoids drilling large holes in the tree by slowly infusing the pesticide into the trunk with a needle-based system and pressure. This system can require an inordinate amount of time to inject a single tree, thus lower its potential for use in a tree fruit orchard system.

Accordingly, it would be desirable to provide a uniform dose of pesticide active ingredient to the tree throughout the growing season in a time- and labor-efficient manner which also enhances the healing of the tree after injection.

### SUMMARY

In one aspect, the disclosure relates to a composite pesticide plug for delivery of one or more dsRNA plant protection materials to internal tree tissue, the composite pesticide plug comprising: (a) a cellulosic material (i.e., for binding the dsRNA), (b) dsRNA (double-stranded RNA) bound to the cellulosic material, the dsRNA having a nucleotide sequence selected to target one or more target tree pests via an RNA-interference (RNAi) mechanism; and, (c) optionally, a thermoplastic polymer matrix, wherein, when the thermoplastic polymer matrix is present, the cellulosic material is distributed throughout the thermoplastic polymer matrix (e.g., with the dsRNA bound to the cellulosic material).

The dsRNA for a given plug can be selected to have a specific sequence such that the dsRNA, when taken up by a target pest, is cleaved and unwound such that the ssRNA fragments can suppress or eliminate mRNAs in the target pest via an RNA interference (RNAi) mechanism. RNAi is an approach for controlling insect pests without the use of synthetic pesticides. In particular, RNAi involves gene suppression by introducing dsRNAs that undergo a “processing pathway” in the cell, that can emanate internally within a target organism cell, subsequently suppressing or eliminating the specific mRNAs in the targeted species required for normal function. It is generally sufficient for the dsRNA to be ingested by the target pest for the dsRNA to have its effect. Once injected into a tree, xylem transport within the tree can transport the dsRNA to the tree canopy and other tree tissues where the dsRNA can be consumed by the target pest to kill or control the pest. Internal tree plug delivery and xylem transport of the dsRNA can help to preserve the activity of the dsRNA, which is typically very sensitive to UV degradation. When the dsRNA is internally delivered and transported throughout the tree, it remains largely shielded from degrading UV radiation before it is consumed from the pest. In contrast, a dsRNA that is applied foliarly to the tree canopy of other exterior environmental surface of the tree can be subject to rapid UV degradation prior to ingestion by the pest. Moreover, by internally delivering and transporting the dsRNA throughout the tree, the dsRNA is not exposed to soil microbes that can also degrade the dsRNA.

A selected dsRNA for a given plug is generally selective to a particular target pest species of interest against which a tree is to be protected. The dsRNA sequence is selected to be complementary or otherwise based on the target pest(s) of interest. Based on the knowledge of the genome for the target pest, which the skilled person can use routine skill to determine, a suitable dsRNA sequence that is selective for that target pest can be selected. Such genomic information is available in various public databases for many pests of interest. In other cases, conventional sequencing techniques can be used to obtain genomic information of other pests not already cataloged in public databases. The dsRNA for agricultural-based target pests (e.g., insects, arachnids, etc.) according to the disclosure are generally exempt from many toxicity-based regulations otherwise generally required for pesticides.

Cellulosic material can have selective nucleic acid-binding properties to dsRNA under proper conditions. The dsRNA can be bound to the cellulosic material via chemical mechanisms and/or physical mechanisms. For example, the dsRNA can be chemically bonded to the cellulosic material via covalent bonds, hydrophobic interactions, hydrogen bonds, ionic bonds, polar and dipole-dipole interactions, and the like. Alternatively or additionally, the dsRNA can be physically bonded to the cellulosic material, such as by being adsorbed to the surface of the cellulosic material as a result of admixing. For example, the dsRNA can be bound to the cellulosic material as a result of admixing the dsRNA with the cellulosic material in an aqueous environment composed of buffered saline with about 15% to about 20% v/v ethanol or other similar alcohol (e.g., methanol, isopropanol, etc.). The dsRNA and cellulosic material solution can be eluted in the presence of a low ionic strength hydrophilic solution. Alternatively or additionally, the composite pesticide plug can include free dsRNA that is not bound, either physically or chemically, to the cellulosic material. In such cases, the free dsRNA is simply present in admixture with the cellulosic material. The free dsRNA similarly has a nucleotide sequence selected to target one or more target tree pests via an RNA-interference (RNAi) mechanism. The free dsRNA suitably can have the same sequence as that of the bound dsRNA and/or have a sequence targeting the same pest as the bound dsRNA. In some embodiments, the free dsRNA and the bound dsRNA can have different sequences and/or target different pests. Advantageously, a mixture of free- and bound-dsRNA can contribute to a sustained and controlled release of the dsRNA from the composite pesticide plug over time, where the free dsRNA is released and transported throughout the tree more quickly, with the bound dsRNA having a delayed release from the plug.

A cellulosic material is a particularly good substrate for dsRNA binding and release, because the dsRNA can be released or eluted from the composite plug within the tree by a low-ionic strength hydrophilic solution, similar to that described above. Typically, the water and/or aqueous fluids that are naturally present in the tree are sufficient for release of the dsRNA from the composite plug via the xylem transport mechanism. In various refinements, and as illustrated in the working examples, the plug can include non-volatile materials, such as salts or other buffer components, when forming the plugs to bind the dsRNA to the cellulose, for example by including such other components in a liquid composition containing the dsRNA, whereupon both of the dsRNA and other components are adsorbed, or otherwise bound, to the surface and/or the pores of the cellulosic material. Such salts and other buffer components can remain in the composite plug when injected (e.g., to a tree trunk), and can assist in the release of the dsRNA when contacted with water (e.g., xylem-transport water) or other aqueous fluid to initiate the xylem-transport mechanism. In some refinements, the plug includes a thermoplastic polymer (e.g., PVOH, PVAc, etc.), which can serve as a binder or a matrix for the cellulosic material and the dsRNA. The thermoplastic polymer components is not required, however, to form a plug that maintains its shape as a solid. For example, a plug formed from a slurry or other mixture of cellulose, dsRNA, and salts/other buffers that is placed into a mold (e.g., a syringe body/barrel) and allowed to dry can form a solid plug.

Various refinements of the disclosed composite pesticide plugs are possible.

In refinements, the cellulosic material is selected from the group consisting of cellulose powder, wood flour, wood fibers, wood chips, wood flakes, and any combination thereof. The cellulosic (or wood) material can be from any suitable source, for example a wood material or other lignocellulosic material. Suitable examples of the cellulosic material include powder, fiber, chip, flake, flour (e.g., sawdust or powder from a hardwood or softwood, for example, cedar, pine, maple, oak, ash, and/or spruce), etc. The cellulosic material is preferably a cellulose powder. Examples of suitable, commercially available, cellulosic powders include, but are not limited to, SIGMACELL CELLULOSE Type 101-F, which is a highly purified, fibrous cellulose powder with an average particle size of about 50 μm.

In refinements, the cellulosic material can be a dried wood flour (e.g., having particle sizes between about 1 μm to about 1,000 μm, such as less than about 850 μm or a 20-mesh-pass size, less than about 500 μm or a 40-mesh-pass size, etc.), for example being dried in an oven for 24-48 hours at 105° C. to a moisture content of less than 1% before compounding and processing. Moisture can also be removed by venting during processing. The cellulosic material can be derived from virgin wood fibers or waste wood byproducts (e.g., urban or demolition wood waste, wood trim pieces, wood milling byproducts, pellets, paper pulp, sawdust, scrap paper/newspaper, etc.). Wood waste originated from plywood, particle board, medium density fiberboard, and CCA-treated timber (i.e., chromated copper arsenate) can also be used.

The cellulosic material can be derived from other lignocellulosic materials, for example, leaves and fruit peels (e.g., orange or other citrus fruit peels, apple pees, etc.). Other suitable cellulosic materials include natural fibers from lignocellulosic materials, such as flax, bagass, jute, hemp, sisal, cotton, ramie, coir, straw, and the like. The cellulosic materials can vary in size, shape, particle size distribution, and aspect ratio (e.g., chips, flake, flours, fibers, etc.). For example, cellulosic materials can have a microscale size, for example having particle sizes ranging from about 1 μm to about 1000 μm (e.g., at least about 1 μm or 10 μm and/or up to about 500 μm, 850 μm, or 1000 μm). In other refinements, cellulosic materials can have a nanoscale size, for example having particle sizes ranging from about 1 nm to about 1000 nm (e.g., at least about 1 nm, 5 nm, 10 nm, or 20 nm and/or up to about 50 nm, 100 nm, 200 nm, 500 nm, or 1000 nm). Examples of suitable nanoscale cellulosic materials include cellulosic nanomaterials, which can be extracted from lignocellulosic materials by known mechanical and/or chemical methods. Cellulosic nanocrystals can have an approximate spherical shape or irregular shape with a low aspect ratio, and cellulosic nanofibers can be a high aspect ratio with a nanoscale diameter and a microscale length. A suitable cellulosic material includes a softwood pine wood flour. Pine wood flour and other relatively porous wood flour are particularly suitable for polymer blending.

In refinements, the cellulosic material comprises cellulose powder.

In refinements, the cellulosic material comprises one or more cellulose derivatives, for example in powder form, fiber form, etc. For example, the cellulosic material can comprise a cellulose derivative selected from the group consisting of carboxymethyl cellulose (CMC) carboxymethyl hydroxyethylcellulose, hydroxyethyl cellulose (HEC), hydroxypropyl cellulose (HPC), hydroxypropyl methylcellulose (HPMC), hydroxyethyl methylcellulose (HPMC), ethyl hydroxyethylcellulose, methyl ethyl hydroxyethylcellulose, methyl cellulose (MC), ethyl cellulose (EC), ethyl methyl cellulose (EMC), diethylaminoethyl cellulose (DEAE-C), a salt thereof, and a combination thereof.

In refinements, the cellulose derivative is carboxymethyl cellulose.

In refinements, the carboxymethyl cellulose is sodium carboxymethyl cellulose.

In refinements, the dsRNA targets one or more tree pests selected from the group consisting of two-spotted spider mite, (Tetranychus urticae), codling moth (Cydia pomonella (L.)), obliquebanded leafroller (Choristoneura rosaceana (Harris)), and brown marmorated stink bug (Halyomorpha halys (Stål)). More generally, the dsRNA can be selected to target a particular pest species such as within the general classes of insect, arachnids, etc. For example, a target insect pest species can be within the Lepidoptera order (e.g., a moth or butterfly species), the Hemiptera order (e.g., a stink bug species), the Diptera order (e.g., a fly or fruit fly species), the Homoptera order (e.g., aphids, psyllids, leafhoppers, etc.), the Coleoptera order (e.g., beetle species such as weevils and tree boring species), etc. Similarly, a target insect pest species can be a mite or spider species, etc.

In refinements, the composite pesticide plug comprises the thermoplastic polymer matrix. As described above, a thermoplastic polymer can be included in the plug and serve as a binder or a matrix for the cellulosic material and the dsRNA. In refinements, the thermoplastic polymer is selected from the group consisting of polyvinyl alcohol (PVOH), polylactic acid (PLA), polyvinyl acetate (PVAc), and combinations thereof. More generally, the thermoplastic polymer can include a water-soluble thermoplastic polymer, such as PVOH, a biodegradable thermoplastic polymer, such as PLA, and/or a non-water soluble thermoplastic polymer, such as PVAc.

In refinements, the thermoplastic polymer comprises a water-soluble thermoplastic polymer. The water-soluble thermoplastic polymer is not particularly limited and can include, for example, thermoplastic polymers (e.g., having a hydrocarbon or hydrocarbon-containing backbone) with one or more polar functional units such as hydroxyl groups, amino groups, carboxylic/carboxylate groups (e.g., acrylic/acrylate groups), and alkylene oxide repeat units. Examples of suitable water-soluble thermoplastic polymers include poly(vinyl alcohol) (PVOH), polyacrylates, polymethacrylates, water-soluble (meth)acrylate copolymers, polyvinyl pyrrolidones, polyethyleneimines, polyalkylene oxides, polyacrylic acids and salts thereof, and combinations thereof (e.g., polymer blends and/or copolymers of the respective monomers). PVOH is a particularly suitable water-soluble thermoplastic polymer. PVOH can include partially or completely hydrolyzed poly(vinyl acetate) with at least some vinyl alcohol repeat units and optionally some vinyl acetate repeat units, and it further can include copolymers with monomers of other than vinyl alcohol and vinyl acetate repeat units. In refinements, the thermoplastic polymer comprises PVOH.

In refinements, the thermoplastic polymer comprises a biodegradable thermoplastic polymer. The biodegradable thermoplastic polymer is not particularly limited and can include, for example, biodegradable thermoplastic polyesters, polyamides, polyethers, copolymers thereof, mixtures thereof, etc. Examples of suitable biodegradable thermoplastic polymers include polyesters such as poly(lactic acid) (PLA), a poly(hydroxyalkanoate) (PHA), a poly(lactone), and combinations thereof (e.g., polymer blends and/or copolymers of the respective monomers). A poly(hydroxyalkanoate) can be a polymer polymerized from a HO—R¹—C(═O)OH monomer and/or including a —O—R¹—C(═O)— repeat unit, where R¹ is a linear or branched alkyl (or alkylene) group with 3 or more carbon atoms (e.g., at least 3 or 4 carbon atoms and/or up to 6, 8, or 10 carbon atoms). Examples of poly(hydroxyalkanoates) include poly-3-hydroxyvalerate (PHV), poly-4-hydroxybutyrate (P4HB), poly-3-hydroxybutyrate (P3HB), poly(3-hydroxybutyrate-co-3-hydroxyvalerate) (PHBV)). A poly(lactone) can be a polymer polymerized from a —O—R²—C(═O)— cyclic ester monomer and/or including a —O—R²—C(═O)— repeat unit, where R² is a linear alkyl (or alkylene) group with 1 or more carbon atoms (e.g., at least 2 or 4 carbon atoms and/or up to 5, 6, 8, or 10 carbon atoms). Examples of poly(lactones) include polyvalerolactone (PCL) and polycaprolactone (PCL)).

In refinements, the thermoplastic polymer comprises a non-water soluble thermoplastic polymer. The non-water soluble thermoplastic polymer is not particularly limited and can include, for example, non-water soluble vinyl polymers, polyesters, polyamides, polyarylene ethers, polyarylene sulfides, polyethersulf ones, polysulfones, polyether ketones, polyether ether ketones, polyurethanes, polycarbonates, polyamide-imides, polyimides, polyetherimides, polyacetals, silicones, mixtures thereof, etc. A vinyl polymer can produced, for example, by carrying out homopolymerization or copolymerization of vinyl monomers. The vinyl polymer can be a rubber-containing graft copolymer produced by graft copolymerization of vinyl monomers (such as styrene, other aromatic vinyl monomers, vinyl cyanide monomers, and other vinyl monomers) or their mixture under the existence of a rubbery polymer, or a vinyl polymer containing a rubbery polymer such as a composition of the former and a vinyl polymer. Specific example of non-water soluble thermoplastic polymers include polyethylene, polypropylene, polystyrene, poly(acrylonitrile-styrene-butadiene) resin (ABS), polytetrafluoroethylene (PTFE), polyacrylonitrile, polyacrylic amide, polyvinyl acetate, polybutyl acrylate, polymethyl methacrylate, and cyclic polyolefin. In refinements, the thermoplastic polymer comprises polyvinyl acetate.

In refinements, the ratio of the cellulose to the thermoplastic polymer is about 1:4 to about 1:1, for example at least about 1:4, 1:3.5, 1:3, 1:2.5, or 1:2 and/or up to about 1:3, 1:2.5, 1:2, 1:1.5, 1:1:1.

In refinements, the thermoplastic polymer matrix is present in an amount ranging from about 10 wt % to about 50 wt %, based on the total weight of the composite pesticide plug; and the cellulosic material is present in an amount ranging from about 30 wt % to about 60 wt %, based on the total weight of the composite pesticide plug. For example, the thermoplastic polymer matrix can be present in an amount of at least about 10, 15, 20, 25, 30, or 35 wt % and/or up to about 25, 30, 35, 40, 45 or 50 wt %, based on the total weight of the composite pesticide plug, and the cellulosic material can be present in an amount ranging from about 30, 35, 40, 45, or 50 wt % and/or up to about 40, 45, 50, 55, or 60 wt %, based on the total weight of the composite pesticide plug.

In refinements, the ratio of the dsRNA to the cellulosic material is in a range of about 1:7.5×10⁵ (i.e., 1:750,000) to about 1:300, for example at least about 1:7.5×10⁵, 1:10⁵, 1:10⁴, 1:1000, 1:900, 1:750, or 1:500 and/or up to about 1:900, 1:750, 1:500, 1:450, 1:400, 1:350, or 1:300.

In another aspect, the disclosure relates to a method for delivering a dsRNA plant protection material to a tree, the method comprising inserting the composite pesticide plug of the disclosure into an interior trunk region of a live tree.

Various refinements of the disclosed method for delivering a dsRNA plant protection material to a tree are possible.

In refinements, the method comprises inserting the composite pesticide plug at height ranging from about 0.1 m to about 1 m above ground, for example at least about 0.1, 0.2, 0.25, 0.3, 0.4, 0.5, 0.6, or 0.7 m and/or up to 0.4, 0.5, 0.6, 0.7, 0.75, 0.8, 0.9, or 1.0 m above ground.

In refinements, the method comprises inserting a plurality of the composite pesticide plugs distributed circumferentially around the tree trunk. For example, at least 2, 3, 4, 5, 6, or 7 and/or up to 5, 6, 7, 8, 9, or 10 composite pesticide plugs can be inserted into the tree trunk. The plurality of pesticide plugs can be distributed evenly around the circumference of the tree trunk, such that the distance between each of the plurality of plugs is the same. Alternatively, or additionally, the plugs can be arranged in clusters of plugs (e.g., at least 2, 3, or 4 and/or up 3, 4, or 5 plugs), and the clusters of plugs can be distributed evenly around the circumference of the tree trunk, such that the distance between each of the clusters is the same. The plurality of plugs (or clusters thereof) can be arranged at the same height (e.g., above ground), or at various heights.

In refinements, the tree is a fruit tree selected from the group consisting of apple trees, cherry trees, grapefruit trees, lemon trees, nectarine trees, orange trees, peach trees, pear trees, plum trees, and pomegranate trees.

In another aspect, the disclosure relates to a method of preparing the composite pesticide plug (e.g., with the thermoplastic polymer matrix) as described herein, the method comprising: admixing the thermoplastic polymer and the cellulosic material to provide a primary composite; forming a hole in the primary composite; and, adding a solution comprising the dsRNA to the hole to provide the composite pesticide plug. In refinements, admixing the thermoplastic polymer and the cellulosic material comprises melt blending the thermoplastic polymer and the cellulosic material at a temperature of about 180° C. to about 355° C., for example at least about 180, 190, 200, 210, 215, 220, 225, 230, 240, or 250° C. and/or up to about 200, 210, 220, 225, 250, 275, 300, 325, 350, or 355° C. In refinements, the thermoplastic polymer comprises polyvinyl alcohol. Addition of the dsRNA to the primary composite can be performed at a temperature of about 15° C. to about 30° C., for example at least about 15, 20, or 25° C. and/or up to about 20, 25, or 30° C., which temperature is sufficiently low to avoid inactivation or other degradation of the dsRNA.

In another aspect, the disclosure provides a method of preparing the composite pesticide plug (e.g., without the thermoplastic polymer matrix) as described herein, the method comprising: admixing the dsRNA with the cellulosic material to provide to the composite pesticide plug. In refinements, the method further comprises admixing the dsRNA with the cellulosic material with a thermoplastic polymer. In refinements, the thermoplastic polymer comprises polyvinyl acetate. In refinements, the method is carried out at a temperature of about 15° C. to about 30° C., for example at least about 15, 20, or 25° C. and/or up to about 20, 25, or 30° C.

While the disclosed composite pesticide plugs and methods are susceptible of embodiments in various forms, specific embodiments of the disclosure are illustrated (and will hereafter be described) with the understanding that the disclosure is intended to be illustrative, and is not intended to limit the claims to the specific embodiments descried and illustrated herein.

### BRIEF DESCRIPTION OF THE DRAWINGS

For a more complete understanding of the disclosure, reference should be made to the following detailed description and accompanying drawings wherein:

FIG. 1A illustrates the amount of dsRNA/25 mg found in leaf tissue, from leaf samples taken from the apple tree canopies over five sampling dates, following injection with dsRNA liquid injection vs. untreated control.

FIG. 1B illustrates excludes the liquid injection treatment the amount of dsRNA/25 mg found in leaf tissue, from leaf samples taken from the apple tree canopies over five sampling dates, following injection with cellulose-PVA plugs and cellulose plugs vs. untreated control.

FIG. 2 illustrates the mortality (+SD) of adult female mites (Tetranychus urticae) exposed for five days to leaf discs cut from apple trees treate with dsRNA.

FIG. 3 illustrates the mean (+SD) percentage survival of mites exposed to leaf discs cut from apple trees with dsRNA.

FIG. 4A illustrates ddPCR quantification data from leaf samples at 3 days after treatment (DAT).

FIG. 4B illustrates ddPCR quantification data from leaf samples at 5 days after treatment (DAT).

FIG. 4C illustrates ddPCR quantification data from leaf samples at 12 days after treatment (DAT).

FIG. 4D illustrates ddPCR quantification data from leaf samples at 26 days after treatment (DAT).

FIG. 4E illustrates ddPCR quantification data from leaf samples at 54 days after treatment (DAT).

FIG. 4F illustrates ddPCR quantification data from leaf samples at 82 days after treatment (DAT).

FIG. 5A illustrates ddPCR quantification of dsRNA per 25 mg leaf tissue from leaf samples taken from apple tree canopies at 56 DAT following injection as compared to liquid injection treatment.

FIG. 5B illustrates ddPCR quantification of dsRNA per 25 mg leaf tissue from leaf samples taken from apple tree canopies at 84 DAT following injection as compared to liquid injection treatment.

FIG. 5C illustrates ddPCR quantification of dsRNA per 25 mg leaf tissue from leaf samples taken from apple tree canopies at 112 DAT following injection as compared to liquid injection treatment.

FIG. 5D illustrates ddPCR quantification of dsRNA per 25 mg leaf tissue from leaf samples taken from apple tree canopies at 140 DAT following injection as compared to liquid injection treatment.

FIG. 6A illustrates amount of dsRNA per 25 mg leaf tissue from leaf sample taken from apple tree canopies following liquid dsRNA injection.

FIG. 6B illustrates amount of dsRNA per 25 mg leaf tissue from leaf sample taken from apple tree canopies following cellulose plug-dsRNA injection.

### DETAILED DESCRIPTION

The disclosure relates to a slow-release biodegradable pesticide plug or composite pesticide plug that can be used for trunk injection delivery of one or more dsRNA plant protection materials to protect woody plants (e.g., trees and fruit trees in particular) against pests. The composite pesticide plug generally includes a cellulosic material, dsRNA (double-stranded RNA) bound to the cellulosic material, the dsRNA having a nucleotide sequence selected to target one or more target tree pests via an RNA-interference (RNAi) mechanism, and optionally, a thermoplastic polymer matrix, wherein the cellulosic material is distributed throughout the thermoplastic matrix. In embodiments without the thermoplastic polymer, the plug may be alternatively referenced as a “pesticide plug” instead of a “composite pesticide plug.” General references herein to “composite pesticide plug” can correspond to either embodiment (i.e., with or without the thermoplastic polymer). After injection into the tree trunk, the composite pesticide plug provides a uniform, relatively consistent dose of active ingredient (e.g., plant protection materials, pesticide, dsRNA, or otherwise) to all parts of the tree throughout the growing season, thus reducing waste of material and cost. The biodegradable nature of the composite pesticide plug also enhances the healing of the tree after injection.

### Composite Pesticide Plug

A composite pesticide plug according to the disclosure includes a cellulosic material, one or more dsRNA plant protection materials, and optionally, a thermoplastic polymer matrix.

The composite pesticide plug can have any desired shape, but it is suitably shaped based on ease of processing and a desire to have a relatively large relative surface area (e.g., surface area/volume or surface area/mass ratio). In some embodiments, the plug has an elongate geometry, which can be suitably formed by extrusion or compression molding as described below and illustrated in the examples. For example, the plug can have a generally cylindrical geometry (e.g., to maximize relative surface area for an elongate or axially symmetric shape), such as having a length (L) of at least 1, 2, 5, 10, 15, or 25 mm and/or up to 10, 20, 30, 50, or 100 mm, and/or having a diameter (D) (or width/equivalent diameter for non-cylinders) of at least 1, 2, 5, or 10 mm and/or up to 5, 8, 10, 15, or 25 mm. The L/D aspect ratio can be at least 1:1 or 2:1 and/or up to 3:1, 4:1, 6:1, or 8:1. The specific geometry/size can be selected to have a desired total volume in terms of amount of active (pesticide) ingredient to be delivered and to have a desired specific surface area (area per unit volume) to control delivery rate. The plug in any form is preferably free from a coating or encapsulating material.

In refinements, the ratio of the dsRNA to the cellulosic material is in a range of about 1:7.5×10⁵ (i.e., 1:750,000) to about 1:300, for example at least about 1:7.5×105, 1:105, 1:104, 1:1000, 1:900, 1:750, or 1:500 and/or up to about 1:900, 1:750, 1:500, 1:450, 1:400, 1:350, or 1:300. Generally, the ratio is provided as a weight ratio, but in some cases it can also be provided as, for example, a volume ratio. Alternatively or independently, the pesticide plug can include about 0.0001 mg to 50 mg, 0.1 mg to 50 mg, 0.2 mg to 20 mg, or 0.5 mg to 10 mg of dsRNA active ingredient, for example including only bound dsRNA, bound and free dsRNA, and/or single or multiple types of dsRNA, for example to target single or multiple pests via single or multiple RNAi pathways. In various embodiments, the pesticide plug can contain at least about 0.0001, 0.001, 0.01, 0.1, 0.2, 0.3, 0.5, 0.7, 1, 2, 3, 5, 7, or 10 mg and/or up to 0.01, 0.1, 0.2, 0.4, 0.8, 1.2, 1.5, 2, 3, 4, 6, 8, 10, 15, 20, 30, 40, or 50 mg of dsRNA active ingredient(s).

In refinements containing a thermoplastic polymer, the ratio of the thermoplastic polymer to the cellulose material can be about 1:4 to about 1:1, for example at least about 1:4, 1:3.5, 1:3, 1:2.5, or 1:2 and/or up to about 1:3, 1:2.5, 1:2, 1:1.5, 1:1:1. For example, the thermoplastic polymer matrix can be present in an amount ranging from about 10 wt % to about 50 wt %, based on the total weight of the composite pesticide plug; and the cellulosic material can be present in an amount ranging from about 30 wt % to about 60 wt % or about 50 wt % to about 90 wt %, based on the total weight of the composite pesticide plug. For example, the thermoplastic polymer matrix can be present in an amount of at least about 10, 15, 20, 25, 30, or 35 wt % and/or up to about 25, 30, 35, 40, 45 or 50 wt %, based on the total weight of the composite pesticide plug, and the cellulosic material can be present in an amount ranging from about 30, 35, 40, 45, 50, 55, or 60 wt % and/or up to about 40, 45, 50, 55, 60, 65, 70, 75, 80, 85 or 90 wt %, based on the total weight of the composite pesticide plug.

### Cellulosic Material

The composite pesticide plugs of the disclosure include a cellulosic material. In some refinements, the cellulosic material includes a cellulose derivative, as described herein. In an aspect, the cellulosic material functions as a substrate to which the dsRNA is bound. In another aspect, the cellulosic material functions to facilitate healing of the tree after injection of the disclosed plugs.

Cellulosic material can have selective nucleic acid-binding properties to dsRNA under proper conditions. Accordingly, a function of the cellulosic material is binding the dsRNA plant protection material. The dsRNA can be bound to the cellulosic material via chemical mechanisms and/or physical mechanisms. For example, the dsRNA can be chemically bonded to the cellulosic material via covalent bonds, hydrophobic interactions, hydrogen bonds, ionic bonds, polar and dipole-dipole interactions, and the like. Alternatively or additionally, the dsRNA can be physically bonded to the cellulosic material, such as by being adsorbed to the surface of the cellulosic material as a result of admixing. For example, the dsRNA can be bound to the cellulosic material as a result of admixing the dsRNA with the cellulosic material in an aqueous environment composed of buffered saline with about 15% to about 20% v/v ethanol or other similar alcohol (e.g., methanol, isopropanol, etc.). The dsRNA and cellulosic material solution can be eluted in the presence of a low ionic strength hydrophilic solution. Alternatively or additionally, the composite pesticide plug can include free dsRNA that is not bound, either physically or chemically, to the cellulosic material. In such cases, the free dsRNA is simply present in admixture with the cellulosic material. The free dsRNA similarly has a nucleotide sequence selected to target one or more target tree pests via an RNA-interference (RNAi) mechanism. The free dsRNA suitably can have the same sequence as that of the bound dsRNA and/or have a sequence targeting the same pest as the bound dsRNA. In some embodiments, the free dsRNA and the bound dsRNA can have different sequences and/or target different pests. Advantageously, a mixture of free- and bound-dsRNA can contribute to a sustained and controlled release of the dsRNA from the composite pesticide plug over time, where the free dsRNA is released and transported throughout the tree more quickly, with the bound dsRNA having a delayed release from the plug.

A cellulosic material is a particularly good substrate for dsRNA binding and release, because the dsRNA can be released or eluted from the composite plug within the tree by a low-ionic strength hydrophilic solution, similar to that described above. Typically, the water and/or aqueous fluids (e.g., tree sap) that are naturally present in the tree are sufficient for release of the dsRNA from the composite plug via the xylem transport mechanism. In various refinements, and as illustrated in the working examples, the plug can include non-volatile materials, such as salts or other buffer components, when forming the plugs to bind the dsRNA to the cellulose, for example by including such other components in a liquid composition containing the dsRNA, whereupon both of the dsRNA and other components are adsorbed, or otherwise bound, to the surface and/or the pores of the cellulosic material. Such salts and other buffer components can remain in the composite plug when injected (e.g., to a tree trunk), and can assist in the release of the dsRNA when contacted with water (e.g., xylem-transport water) or other aqueous fluid to initiate the xylem-transport mechanism.

The bound nucleic acids from the cellulosic material are released, or “eluted” upon contact with a hydrophilic solution (e.g. water; low-ionic strength solutions such as a Tris EDTA buffer, saline solution, etc.). Without wishing to be bound to any particular theory, the dsRNA is “released” when the dsRNA-containing composite pesticide plug, delivered by trunk injection in a tree, is bathed, immersed, or otherwise contacted by the tree's hydrophilic vascular fluids (e.g., tree sap), whereby the composite pesticide plug first disintegrates gradually followed by the exposure of its cellulosic material content to the tree fluids leading to the elution of the dsRNA. The eluted dsRNA then travels to the vasculature of the tree in an ascending manner for deposition into the canopy or leaf tissue where it can exhibit its pesticidal effect upon ingestion by a target pest.

The cellulosic material may be from any suitable source, for example a wood material or other lignocellulosic material, including chemically modified derivatives thereof. In refinements, the cellulosic material is selected from the group consisting of cellulose powder, wood flour, wood fibers, wood chips, wood flakes, and any combination thereof. The cellulosic (or wood) material can be from any suitable source, for example a wood material or other lignocellulosic material. Suitable examples of the cellulosic material include powder, fiber, chip, flake, flour (e.g., sawdust or powder from a hardwood or softwood, for example, cedar, pine, maple, oak, ash, and/or spruce), etc. In some refinements, the cellulosic material is a cellulose powder. Examples of suitable, commercially available, cellulosic powders include, but are not limited to, SIGMACELL CELLULOSE Type 101-F, which is a highly purified, fibrous cellulose powder with an average particle size of about 50 μm.

In refinements, the cellulosic material can be a dried wood flour (e.g., having particle sizes between about 1 μm to about 1,000 μm, such as less than about 850 μm or a 20-mesh-pass size, less than about 500 μm or a 40-mesh-pass size, etc.), for example being dried in an oven for 24-48 hours at 105° C. to a moisture content of less than 1% before compounding and processing. Moisture can also be removed by venting during processing. The cellulosic material can be derived from virgin wood fibers or waste wood byproducts (e.g., urban or demolition wood waste, wood trim pieces, wood milling byproducts, pellets, paper pulp, sawdust, scrap paper/newspaper, etc.). Wood waste originated from plywood, particle board, medium density fiberboard, and CCA-treated timber (i.e., chromated copper arsenate) can also be used.

The cellulosic material can be derived from other lignocellulosic materials, for example, leaves and fruit peels (e.g., orange or other citrus fruit peels, apple pees, etc.). Other suitable cellulosic materials include natural fibers from lignocellulosic materials, such as flax, bagass, jute, hemp, sisal, cotton, ramie, coir, straw, and the like. The cellulosic materials can vary in size, shape, particle size distribution, and aspect ratio (e.g., chips, flake, flours, fibers, etc.). For example, cellulosic materials can have a microscale size, for example having particle sizes ranging from about 1 μm to about 1000 μm (e.g., at least about 1 μm or 10 μm and/or up to about 500 μm, 850 μm, or 1000 μm). In other refinements, cellulosic materials can have a nanoscale size, for example having particle sizes ranging from about 1 nm to about 1000 nm (e.g., at least about 1 nm, 5 nm, 10 nm, or 20 nm and/or up to about 50 nm, 100 nm, 200 nm, 500 nm, or 1000 nm). Examples of suitable nanoscale cellulosic materials include cellulosic nanomaterials, which can be extracted from lignocellulosic materials by known mechanical and/or chemical methods. Cellulosic nanocrystals can have an approximate spherical shape or irregular shape with a low aspect ratio, and cellulosic nanofibers can be a high aspect ratio with a nanoscale diameter and a microscale length. A suitable cellulosic material includes a softwood pine wood flour. Pine wood flour and other relatively porous wood flour are particularly suitable for polymer blending.

In some refinements, the cellulosic material includes one or more cellulose derivatives, for example in powder form, fiber form, etc. A cellulose derivative generally has one or more of its functional groups (e.g., native hydroxy groups) on glucose units of the cellulose chain replaced with one or more different functional groups. Selection of a particular cellulose derivative can improve or otherwise adjust one or more physical or chemical properties of the cellulosic material, such as water swellability, water solubility, etc. For example, in some instances the cellulose derivative can function to improve the release of active ingredients. The cellulose derivative (e.g., sodium carboxymethyl cellulose) completely dissolves in the presence of tree sap, thus providing improved release of active ingredients. Without wishing to be bound to any particular theory, it is believed that the complete dissolution of the cellulose derivative minimizes the risk of particulates plugging xylem tissues following trunk injection. In addition, the cellulose derivative also can function in healing the tree. In instances, where the cellulose derivative swells (e.g., due to the absorption of water) after trunk injection, the swelled cellulose derivative can form a gel-like consistency that expands to fill the bore hole leaving no air space in the cavity. Without wishing to be bound to any particular theory, it is believed that this leads to improved distribution of the dsRNA plant protection material as well improved healing of the tree by filling the bore hole.

More generally, the cellulose derivative can include cellulose ethers with —OR substituents in place of some or all —OH groups in the cellulose backbone. R can be a substituted or an unsubstituted alkyl group, for example a C1, C2, C3, C4, C5, or C6 linear or branched alkyl group. The cellulose ethers can have one or more than type of substituting group R. The cellulose derivatives can be partially or fully substituted with degrees of substitution up to 3, for example at least 1, 1.2, 1.4, 1.6, 1.8 or 2 and/or up to 1.5, 1.7, 2, 2.3, 2.6, or 3. The degree of substitution represents an (average) number of —OH groups per glucose unit in the cellulosic chain that are replaced by one or more different —OR groups. Unsubstituted alkyl groups can include methyl, ethyl, propyl, isopropyl, butyl, isobutyl, tert-butyl groups, etc., for example a methyl group as in methyl cellulose and hydroxypropyl methylcellulose. Substituted alkyl groups can include hydroxylated alkyl groups, for example a hydroxypropyl group as in hydroxypropyl cellulose and hydroxypropyl methylcellulose. Substituted alkyl groups can include carboxylated alkyl groups and salts thereof (e.g., sodium salt), for example a carboxymethyl group as in carboxymethyl cellulose. Substituted alkyl groups can include aminated alkyl groups and salts thereof (e.g., chloride ammonium salt), such as a dialkylamine group as in diethylaminoethyl cellulose (DEAE-C).

In refinements, the cellulosic material includes a cellulose derivative selected from the group consisting of carboxymethyl cellulose (CMC) carboxymethyl hydroxyethylcellulose, hydroxyethyl cellulose (HEC), hydroxypropyl cellulose (HPC), hydroxypropyl methylcellulose (HPMC), hydroxyethyl methylcellulose (HPMC), ethyl hydroxyethylcellulose, methyl ethyl hydroxyethylcellulose, methyl cellulose (MC), ethyl cellulose (EC), ethyl methyl cellulose (EMC), diethylaminoethyl cellulose (DEAE-C), a salt thereof, and a combination thereof.

In refinements, the cellulose derivative is carboxymethyl cellulose.

In refinements, the carboxymethyl cellulose is sodium carboxymethyl cellulose.

The amount of cellulosic material incorporated into the composite pesticide plug is not particularly limited. In various embodiments, the amount of the cellulosic material in the composite pesticide plug ranges from 30 wt. % to 85 wt. % relative to the combined amount of the thermoplastic polymer matrix (when present) and the cellulosic material. The cellulosic material amount can include all cellulosic species combined when there is more than one type in the plug. The relevant weight basis for the cellulosic material amount includes thermoplastic polymers (e.g., water-soluble and/or biodegradable thermoplastic polymers) when present and cellulosic materials(s), but excludes the dsRNA plant protection material component and any other optional additives or components in the plug. More generally, the amount of the cellulosic material in the composite pesticide plug can be at least 30, 40, 50, or 60 wt. % and/or up to 50, 60, 65, 70, 80, or 85 wt. % relative to the combined amount of the thermoplastic polymer matrix (when present) and the cellulosic reinforcement. In embodiments without the thermoplastic polymer matrix, the amount of the cellulosic material in the pesticide plug ranges from 80 wt. % to 99.9 wt. % relative to the pesticide plug as a whole. For example, the pesticide plug can contain at least about 80, 85, 90, 95, 98, or 99 wt. % and/or up to about 90, 95, 98, 99, 99.5, 99.9 wt. % cellulosic materials, such as where the balance can include the dsRNA component and any optional non-cellulosic components.

dsRNA Plant Protection Material

The composite pesticide plugs of the disclosure include one or more dsRNA plant protection materials for delivery to internal tree tissue. The dsRNA for a given plug advantageously can be selected to have a specific sequence to target a specific pest. For example, when the dsRNA is taken up taken up by a target pest, the dsRNA is cleaved and unwound to form ssRNA fragments, which can bind to, suppress, and/or eliminate mRNAs in the target pest via an RNAi mechanism. As such, in an aspect the disclosed plugs provide an approach for controlling pests without the use of synthetic pesticides.

Moreover, the disclosed composite pesticide plugs advantageously provide internal delivery of the dsRNA plant protection materials to tree tissue. Internal tree plug delivery and xylem transport of the dsRNA can help to preserve the activity of the dsRNA, which is typically very sensitive to UV degradation. When the dsRNA is internally delivered and transported throughout the tree, it remains largely shielded from degrading UV radiation before it is consumed by the pest. In contrast, a dsRNA that is applied foliarly to the tree canopy of other exterior environmental surface of the tree can be subject to rapid UV degradation prior to ingestion by the pest. Moreover, by internally delivering and transporting the dsRNA throughout the tree, the dsRNA is not exposed to soil microbes that can also degrade the dsRNA.

RNAi involves gene suppression by introducing dsRNAs that undergo a “processing pathway” in the cell, that can emanate internally within a target organism cell, subsequently suppressing or eliminating the specific mRNAs in the targeted species required for normal function. It is generally sufficient for the dsRNA to be ingested by the target pest for the dsRNA to have its effect. Once injected into a tree, xylem transport within the tree can transport the dsRNA to the tree canopy (or leaves) and other tree tissues where the dsRNA can be consumed by the target pest to kill or control the pest.

A selected dsRNA for a given plug is generally selective to a particular target pest species of interest against which a tree is to be protected. The dsRNA sequence is selected to be complementary or otherwise based on the target pest(s) of interest. Based on the knowledge of the genome for the target pest, which the skilled person can use routine skill to determine, a suitable dsRNA sequence that is selective for that target pest can be selected. Such genomic information is available in various public databases for many pests of interest. In other cases, conventional sequencing techniques can be used to obtain genomic information of other pests not already cataloged in public databases. Likewise, conventional RNA synthesis techniques can be used to prepare dsRNA with the desired sequence to target a given pest. Accordingly, given a target pest of interest, selection and synthesis of a corresponding dsRNA to target the pest via the RNAi mechanism can be performed using information and techniques routinely available to the skilled artisan. The dsRNA for agricultural-based target pests (e.g., insects, arachnids, etc.) according to the disclosure are generally exempt from many toxicity-based regulations otherwise generally required for pesticides.

In some embodiments, the dsRNA can be selected to target a particular pest species such as within the general classes of insect, arachnids, etc. For example, a target insect pest species can be within the Lepidoptera order (e.g., a moth or butterfly species), the Hemiptera order (e.g., a stink bug species), the Diptera order (e.g., a fly or fruit fly species), the Homoptera order (e.g., aphids, psyllids, leafhoppers, etc.), the Coleoptera order (e.g., beetle species such as weevils and tree boring species), etc. Similarly, a target insect pest species can be a mite or spider species, etc. In some embodiments, the dsRNA targets one or more tree pests such as two-spotted spider mites (Tetranychus urticae), codling moths (Cydia pomonella (L.)), obliquebanded leaf rollers (Choristoneura rosaceana (Harris)), and brown marmorated stink bugs (Halyomorpha halys (Stål)).

### Thermoplastic Polymer Matrix

In some embodiments, the disclosed composite pesticide plugs include a thermoplastic polymer matrix. For example, the plug can include a thermoplastic polymer such as polyvingyl alcohol (PVOH), polyvinyl acetate (PVAc), etc., which can also serve as a binder or a matrix for the cellulosic material and the dsRNA. The thermoplastic polymer component is not required, however, to form a plug that maintains its shape as a solid. For example, a plug formed from a slurry or other mixture of cellulosic material, dsRNA, and salts/other buffers that is placed into a mold (e.g., a syringe body/barrel) and allowed to dry can form a solid plug.

The thermoplastic polymer matrix generally forms a continuous phase for the composite pesticide plug. Examples of general thermoplastic polymers include water-soluble thermoplastic polymers, non-water-soluble thermoplastic polymers, and biodegradable thermoplastic polymers. When two or more thermoplastic polymers are used for the thermoplastic polymer matrix (e.g., the water-soluble thermoplastic polymer, the non-water-soluble thermoplastic polymer, the biodegradable thermoplastic polymer, and any other optional thermoplastic polymers included), they generally form a miscible blend as a continuous, homogeneous polymeric phase. The cellulosic material with dsRNA bound thereto is distributed throughout the thermoplastic polymer matrix, for example as discrete, heterogeneous particles essentially evenly distributed throughout the continuous phase. The inclusion of the cellulosic material in a substantial amount in the plug enhances biodegradability of the plug and eventual healing of the tree after injection. In some embodiments and in addition to being bound to the cellulosic material, the one or more dsRNA plant protection materials also can be present in the thermoplastic polymer matrix, for example being homogeneously distributed throughout the thermoplastic polymer matrix.

The thermoplastic polymer can be adapted to form the thermoplastic polymer matrix and the composite plug at a temperature below a degradation or inactivation temperature of the dsRNA plant protection material. In some embodiments, the thermoplastic polymer includes polyvinyl acetate (PVAc) or other non-water soluble thermoplastic polymer. In some embodiments, the thermoplastic polymer is in the form of a latex. In some embodiments, the thermoplastic polymer is adapted to form the thermoplastic polymer matrix and the composite plug at a temperature below 120° C., for example below 30, 50, 70, 90° C., where such temperature thresholds can be representative of degradation or inactivation temperatures for some dsRNAs. In some embodiments, the thermoplastic polymer is adapted to form the thermoplastic polymer matrix and the composite plug at a temperature in a range from 5° C. to 30° C., for example at a temperature of at least about 5, 10, 15, 20, 22, or 25° C. and/or up to about 22, 25, 27, or 30° C. More generally, the thermoplastic polymer is adapted to be combined with the cellulosic material and the dsRNA and then formed into a corresponding thermoplastic polymer matrix and composite plug without requiring melting or other high-temperature processing of the thermoplastic polymer. For example, a thermoplastic polymer initially in the form of an aqueous (or other liquid) dispersion of thermoplastic polymer microparticles is adapted to form a corresponding thermoplastic polymer in the form of a latex via drying/evaporation of the liquid medium and/or (partial) coalescence of the microparticles to form the latex matrix without elevated temperature processing.

In refinements, the thermoplastic polymer includes a non-water soluble thermoplastic polymer. The non-water soluble thermoplastic polymer is not particularly limited and can include, for example, non-water soluble vinyl polymers, polyesters, polyamides, polyarylene ethers, polyarylene sulfides, polyethersulf ones, polysulfones, polyether ketones, polyether ether ketones, polyurethanes, polycarbonates, polyamide-imides, polyimides, polyetherimides, polyacetals, silicones, mixtures thereof, etc. A vinyl polymer can produced, for example, by carrying out homopolymerization or copolymerization of vinyl monomers. The vinyl polymer can be a rubber-containing graft copolymer produced by graft copolymerization of vinyl monomers (such as styrene, other aromatic vinyl monomers, vinyl cyanide monomers, and other vinyl monomers) or their mixture under the existence of a rubbery polymer, or a vinyl polymer containing a rubbery polymer such as a composition of the former and a vinyl polymer. Specific examples of non-water soluble thermoplastic polymers include polyethylene, polypropylene, polystyrene, poly(acrylonitrile-styrene-butadiene) resin (ABS), polytetrafluoroethylene (PTFE), polyacrylonitrile, polyacrylic amide, polyvinyl acetate, polybutyl acrylate, polymethyl methacrylate, and cyclic polyolefin. In refinements, the thermoplastic polymer includes polyvinyl acetate.

The water-soluble thermoplastic polymer component, when present, may or may not be relatively biodegradable, but it generally contains polar functional groups (e.g., hydroxyl groups, amino groups) that provide it with some degree of water solubility and/or ability to hydrogen-bond with water. Water solubility and/or hydrogen bonding facilitate release of the one or more dsRNA plant protection materials and delivery of the same throughout the tree. When exposed to water transport in xylem tissue (and optionally phloem tissue), the water can solubilize the water-soluble thermoplastic polymer, thus releasing the one or more dsRNA plant protection materials from the plug. Water-based xylem transport (and to some extent phloem transport) can then deliver the released one or more dsRNA plant protection materials (e.g., along with the water-soluble thermoplastic polymer) to various plant tissues including the trunk (e.g., at or above locations where the plug is injected), branches (e.g., scaffold branches, lateral branches), stems, leaves, etc. The biodegradable thermoplastic polymer is generally relatively water-insoluble (e.g., relative to the water-soluble thermoplastic polymer), and it provides some additional structural integrity to the matrix relative to the water-soluble thermoplastic polymer. Its biodegradable nature assists in eventual tree healing after plug injection, and its water-insoluble nature limits the amount of polymer material carried away via xylem transport. Too high of a water-soluble thermoplastic polymer content in the plug could lead to correspondingly high concentrations of the water-soluble thermoplastic polymer in the xylem tissue after release, possibly resulting in deposition of solid water-soluble thermoplastic polymer in the xylem tissue. Such deposits can obstruct further delivery of the one or more dsRNA plant protection materials and limit the effectiveness of the plug's controlled release properties.

The water-soluble thermoplastic polymer is not particularly limited and can include, for example, thermoplastic polymers (e.g., having a hydrocarbon or hydrocarbon-containing backbone) with one or more polar functional units such as hydroxyl groups, amino groups, carboxylic/carboxylate groups (e.g., acrylic/acrylate groups), and alkylene oxide repeat units. Examples of suitable water-soluble thermoplastic polymers include poly(vinyl alcohol) (PVOH), polyacrylates, polymethacrylates, water-soluble (meth)acrylate copolymers, polyvinyl pyrrolidones, polyethyleneimines, polyalkylene oxides, polyacrylic acids and salts thereof, and combinations thereof (e.g., polymer blends and/or copolymers of the respective monomers). PVOH is a particularly suitable water-soluble thermoplastic polymer. PVOH can include partially or completely hydrolyzed poly(vinyl acetate) with at least some vinyl alcohol repeat units and optionally some vinyl acetate repeat units, and it further can include copolymers with monomers of other than vinyl alcohol and vinyl acetate repeat units.

The amount of the water-soluble thermoplastic polymer incorporated into the composite pesticide plug is not particularly limited. In various embodiments, the water-soluble thermoplastic polymer is present in the composite pesticide plug in an amount ranging from 5 wt. % to 40 wt. % relative to the combined amount of the thermoplastic polymer matrix and the cellulosic material. The water-soluble thermoplastic polymer amount can include all water-soluble thermoplastic polymer species combined when there is more than one type in the plug. The relevant weight basis for the water-soluble thermoplastic polymer amount includes thermoplastic polymers (e.g., water-soluble and/or biodegradable thermoplastic polymers) and cellulosic materials, but excludes the dsRNA plant protection component and any other optional additives or components in the plug. More generally, the amount of the water-soluble thermoplastic polymer in the composite pesticide plug can be at least 2, 5, 10, or 15 wt. % and/or up to 10, 20, 25, 30, 40, or 50 wt. %.

The biodegradable thermoplastic polymer is not particularly limited and can include, for example, biodegradable thermoplastic polyesters, polyamides, polyethers, copolymers thereof, mixtures thereof, etc. Examples of suitable biodegradable thermoplastic polymers include polyesters such as poly(lactic acid) (PLA), a poly(hydroxyalkanoate) (PHA), a poly(lactone), and combinations thereof (e.g., polymer blends and/or copolymers of the respective monomers). A poly(hydroxyalkanoate) can be a polymer polymerized from a HO—R¹—C(═O)OH monomer and/or including a —O—R¹—C(═O)— repeat unit, where R¹ is a linear or branched alkyl (or alkylene) group with 3 or more carbon atoms (e.g., at least 3 or 4 carbon atoms and/or up to 6, 8, or 10 carbon atoms). Examples of poly(hydroxyalkanoates) include poly-3-hydroxyvalerate (PHV), poly-4-hydroxybutyrate (P4HB), poly-3-hydroxybutyrate (P3HB), poly(3-hydroxybutyrate-co-3-hydroxyvalerate) (PHBV)). A poly(lactone) can be a polymer polymerized from a —O—R²—C(═O)— cyclic ester monomer and/or including a —O—R²—C(═O)— repeat unit, where R² is a linear alkyl (or alkylene) group with 1 or more carbon atoms (e.g., at least 2 or 4 carbon atoms and/or up to 5, 6, 8, or 10 carbon atoms). Examples of poly(lactones) include polyvalerolactone (PCL) and polycaprolactone (PCL)).

The amount of the biodegradable thermoplastic polymer incorporated into the composite pesticide plug is not particularly limited. In various embodiments, the biodegradable thermoplastic polymer is present in the composite pesticide plug in an amount ranging from 10 wt. % to 50 wt. % relative to the combined amount of the thermoplastic polymer matrix and the cellulosic material. The biodegradable thermoplastic polymer amount can include all biodegradable thermoplastic polymer species combined when there is more than one type in the plug. The relevant weight basis for the biodegradable thermoplastic polymer amount includes thermoplastic polymers (e.g., water-soluble, non-water-soluble and/or biodegradable thermoplastic polymers) and cellulosic materials but excludes the dsRNA plant protection component and any other optional additives or components in the plug. More generally, the amount of the biodegradable thermoplastic polymer in the composite pesticide plug can be at least 5, 10, 15, or 20 wt. % and/or up to 10, 20, 30, 40, 50, or 60 wt. %.

In various embodiments, the ratio of the biodegradable thermoplastic polymer to the water-soluble thermoplastic polymer in the composite pesticide plug ranges from 1 to 3 (e.g., at least 1, 1.2, 1.4 or 1.5 and/or up to 1.5, 2, 2.5, or 3). As described above, some water-soluble thermoplastic polymer is desirable to assist with plug dissolution, pesticide release, and water-based transport of the pesticide in the tree, but too much water-soluble thermoplastic polymer could block internal tree passages (e.g., xylem and/or phloem tissue) and inhibit pesticide delivery. The biodegradable thermoplastic polymer provides additional material which helps to form the thermoplastic matrix for the composite, but which is also biodegradable in place where it inserted (e.g., without potentially blocking downstream water transport tissue).

### Optional Components

Although generally described herein for use in combination with and for delivery of a dsRNA plant protection material, the pesticide plug or composite pesticide plug can more generally include any active ingredient other than dsRNA for delivery to internal tree tissue. Examples of such active ingredients can include any of the various plant protection materials know in the art for promoting tree health, such as materials which kill or inactivate tree pests, increase a tree's resistance to pests, and/or promote tree growth, etc. Plant protection materials can include pesticides (e.g., synthetic pesticides), biopesticides, plant growth regulators, and fertilizers, for example. The pesticide plug can include multiple different types of plant protection materials, for example two or more plant protection materials of the same or different type (e.g., two different types of pesticide, one pesticide and one fertilizer, etc.). The pesticide is not particularly limited and can include any pesticides (e.g., insecticides, fungicides, miticides and/or antibiotics used for tree health) that target one or more tree pests. Suitable classes of pesticides include neonicotinoids, avermectins, azadirachtin, diamides (e.g., diamide insecticides), sterol inhibitors (e.g., sterol inhibitor fungicides), oxytetracycline (e.g., a tetracycline group antibiotic), phosphorous acid, derivatives thereof, and combinations or mixtures thereof. Example derivative forms include salts such as metal salts (e.g., alkali and/or alkali earth metal salt) and amine salts (e.g., as mono-, di-, or tri-alkyl or alkanol amine; amine salt with a halogen such as chloride or a carboxylate such as benzoate), esters (e.g., alkyl esters), and amides. Example neonicotinoids include acetamiprid, clothianidin, imidacloprid, nitenpyram, nithiazine, thiacloprid, and thiamethoxam. Example avermectins include ivermectin, selamectin, doramectin, abamectin, and emamectin (a 4″-deoxy-4″-methylamino derivative of abamectin, such as in the form of a benzoic acid amine salt). Example diamides include broflanilide, cyantraniliprole, flubendiamide, and chlorantraniliprole. Example sterol inhibitors include triazole fungicides (e.g., tebuconazole, propiconazole), imidazoles (e.g., imazalil), and pyrimidines (e.g., fenarimol). Biopesticides are generally known in the art and can target one or more types of tree pests as do pesticides, but they are derived from natural materials such as animals, plants, bacteria, and certain minerals. Plant growth regulators are generally known in the art and can include various synthetic or natural substances that stimulate or otherwise regulate plant growth in a manner or mechanism similar to that of natural plant hormones. Fertilizers, whether specifically tailored for trees specifically or plants more generally, are generally known in the art and can include one or more plant nutrients such as macronutrients (e.g., nitrogen, phosphorus, potassium, calcium, sulfur, and/or magnesium) or micronutrients (e.g., trace minerals such as boron, chlorine, manganese, iron, zinc, copper, molybdenum, nickel, and/or cobalt) desired to supplement the nutrients from the tree's local soil environment. In refinements, the active ingredient(s) other than dsRNA can be suitably homogeneously distributed throughout the thermoplastic polymer matrix of the plug. For example, the active ingredient(s) can be present as a miscible blend with the polymeric components of the plug matrix.

The active ingredient(s) can be present in any desired concentration in the plug, which concentration is generally guided by manufacturer's instructions and/or regulatory limits for dosage for a particular target tree and/or in a target environment. For example, the active ingredient(s) can be present in the composite pesticide plug in an amount ranging from 1 wt. % to 50 wt. % relative to the combined amount of the thermoplastic polymer matrix (when present) and the cellulosic material. The relevant weight basis for the pesticide amount includes thermoplastic polymers (when present) and cellulosic material(s), but excludes the active ingredient(s) and any other optional additives or components in the plug. More generally, the amount of the active ingredient(s) in the composite pesticide plug can be at least 1, 2, 3, 5, 10, 15, 20, 30, or 40 wt. % and/or up to 3, 5, 10, 20, 30, 40, or 50 wt. % relative to the combined amount of the thermoplastic polymer matrix and the cellulosic material. The various active ingredient amounts and ranges can represent single active ingredient components and/or all active ingredient components combined when there is more than one type.

Method for dsRNA Plant Protection Material Delivery

In another aspect, the disclosure relates to a method for delivering a dsRNA plant protection material to a tree, the method including inserting the composite pesticide plug of the disclosure into an interior trunk region of a live tree.

The composite pesticide plug according to any of its variously disclosed embodiments can be used to deliver a relatively uniform, consistent amount of its one or more dsRNA plant protection materials to internal tree tissue over time to tree tissue at or above the plug's point of insertion into the tree. When present, the thermoplastic polymer in general (e.g., PVAc or otherwise) can provide mechanical strength to the plug to maintain its shape during storage, transport, and tree insertion. The water-soluble nature of the water-soluble thermoplastic polymer (when present) assists in pesticide release and aqueous delivery of the pesticide via xylem (and optionally phloem) transport. The biodegradable nature of the biodegradable thermoplastic polymer (when present) and the cellulosic material assists in healing of the tree after insertion of the plug. The plug is inserted into an interior region of a live tree (e.g., into the trunk, one or more branches, etc.) in a suitable number and at a suitable position (e.g., a suitable height above ground) in the tree. After insertion, natural water and/or sap transport within the tree will release and deliver the one or more dsRNA plant protection materials to internal tree tissue from the plug. Inserting the plug can involve drilling a hole in the tree trunk with a diameter generally corresponding to that if the plug and a desired depth, and then inserting the plug into the hole. The manner of plug insertion is not particularly limited, however, and any suitable mechanical means may be used (e.g., a mechanical device or tool that can insert the plug with or without the use of a drill). The length of the plug and its insertion depth into the trunk are generally selected to provide maximum exposure of the plug's outer surface area to active xylem and/or phloem tissues, which are immediately under the bark of the tree. Suitable depths can be determined by the skilled artisan based on the type and size of tree for injection.

The composite pesticide plug is generally inserted into a lower portion of the tree trunk, typically between the ground and the first set of scaffold limbs or branches above the ground. Injection at such point ensures that xylem transport of the pesticide will reach most or essentially all plant tissue above the insertion point, given that xylem transport of water initiates at the roots and travels upwards to the plant tissue extremities. By way of non-limiting example for various common trees of interest, the composite pesticide plug can be inserted at a height ranging from 0.1 m to 1 m above the ground (e.g., a height of at least 0.1 or 0.2 m and/or up to 0.3, 0.5, or 1 m). In apple trees, for example, the first set of scaffold limbs occur at or above about 0.3 m, so an insertion point below 0.3 m is desirable. In embodiments, the method includes inserting the composite pesticide plug at a height ranging from about 0.1 m to about 1 m above ground, for example at least about 0.1, 0.2, 0.25, 0.3, 0.4, 0.5, 0.6, or 0.7 m and/or up to 0.4, 0.5, 0.6, 0.7, 0.75, 0.8, 0.9, or 1.0 m above ground.

For a given tree, multiple composite pesticide plugs are suitably inserted into the tree at multiple positions distributed around the tree trunk (e.g., circumferentially distributed). The total number of plugs for a given tree increases as the trunk diameter increases. Larger trees need more active ingredient because they have more canopy. Xylem is sectored within the tree such that multiple plugs are needed to attain an even distribution of product in the tree canopy. For example, 2, 3, 4, 5, 6, 8, 10, 12, 15, 20, or more plugs can be distributed around the circumference of the tree trunk at approximately even intervals (e.g., at approximately 360°/n intervals where n is the number of plugs inserted into the tree trunk).

In embodiments, the method includes inserting a plurality of the composite pesticide plugs distributed circumferentially around the tree trunk. For example, at least 2, 3, 4, 5, 6, or 7 and/or up to 5, 6, 7, 8, 9, or 10 plugs can be inserted into the tree trunk. The plurality of composite pesticide plugs can be distributed evenly around the circumference of the tree trunk, such that the distance between each of the plurality of plugs is the same. Alternatively, or additionally, the plugs can be arranged in clusters of plugs (e.g., at least 2 3, or 4 and/or up 3, 4, or 5 plugs), and the clusters of plugs can be distributed evenly around the circumference of the tree trunk, such that the distance between each of the clusters is the same. The plurality of plugs (or clusters thereof) can be arranged at the same height (e.g., above ground), or at various heights.

The types of trees that can be treated with the composite pesticide plug are not particularly limited and can be trees in a cultivated area (e.g., orchard), a nursery, or a wild area (e.g., forest), for example. Suitable types of trees include fruit trees, ornamental trees, forest trees, etc. Examples of specific fruit trees of interest include apple trees, cherry trees, grapefruit trees, lemon trees, lime trees, nectarine trees, orange trees, peach trees, pear trees, plum trees, and pomegranate trees. In embodiments, the tree is a fruit tree such as one or more of apple trees, cherry trees, grapefruit trees, lemon trees, nectarine trees, orange trees, peach trees, pear trees, plum trees, and pomegranate trees.

### Methods of Preparing Composite Pesticide Plugs

In another aspect, the disclosure relates to a method of preparing the composite pesticide plug as described herein. The method generally includes admixing the dsRNA with the cellulosic material to provide the composite pesticide plug.

In another aspect, the disclosure relates to a method of preparing the composite pesticide plug with the thermoplastic polymer matrix as described herein. The method includes admixing the thermoplastic polymer and the cellulosic material to provide a primary composite; forming a hole in the primary composite; and, adding a solution comprising the dsRNA to the hole to provide the composite pesticide plug. The thermoplastic polymer matrix components, the cellulosic material, and any desired other additives (e.g., processing aids or functional components) can be dry mixed in the desired proportions for the final plug, for example being initially dried at an elevated temperature (e.g., 50° C. to 150° C., but lower than the melt temperature of any polymer components) prior to any melt processing. In refinements, admixing the thermoplastic polymer and the cellulosic material includes melt blending the thermoplastic polymer and the cellulosic material at a temperature of about 180° C. to about 355° C., for example at least about 180, 190, 200, 210, 215, 220, 225, 230, 240, or 250° C. and/or up to about 200, 210, 220, 225, 250, 275, 300, 325, 350, or 355° C. In refinements, the dry mixture can be melt blended first and then melt processed into its desired plug shape using any suitable methods, for example including extrusion, compression molding, injection molding, etc. In other embodiments, the dry mixture can be can be melt processed directly into its desired plug shape using any suitable methods as described above. Addition of the dsRNA to the primary composite can be performed at a temperature of about 15° C. to about 30° C., for example at least about 15, 20, or 25° C. and/or up to about 20, 25, or 30° C., which temperature is sufficiently low to avoid inactivation or other degradation of the dsRNA.

In another aspect, the disclosure provides a method of preparing the composite pesticide plug, for example with or without the thermoplastic polymer matrix as described herein. The method includes admixing the dsRNA with the cellulosic material for a time sufficient to adsorb, absorb, or otherwise bind the dsRNA to the cellulosic material to provide to the composite pesticide plug. In refinements, the method further includes admixing the dsRNA with the cellulosic material with a thermoplastic polymer, in particular with a thermoplastic polymer such as polyvinyl acetate that can solidify and form a solid polymer matrix at low temperatures to avoid inactivation or other degradation of the dsRNA. In refinements, the method is carried out at a temperature of about 15° C. to about 30° C., for example at least about 15, 20, or 25° C. and/or up to about 20, 25, or 30° C.

The following describes an illustrative procedure for preparing a composite pesticide plug in accordance with embodiments of the disclosure.

A manufactured dsRNA stock solution (5-10 mg/mL) is obtained. The dsRNA is precipitated from the aqueous solution by adding 1/10 volume of 3 M sodium acetate (pH 5.2) and 2.5 volumes of ethanol (EtOH) followed by pelleting down the precipitate by centrifugation at 4,000 rpm for 10 minutes. The clear EtOH/salt buffer solution is decanted from the tube leaving the intact dsRNA pellet at the bottom of the tube. Sodium carboxymethyl cellulose powder (1 g) is mixed into the dsRNA pellet (containing at least 100-300 mg of dsRNA) followed by addition of 200-300 μl of the decanted EtOH/salt buffer solution until a homogenous dough mixture is obtained. This final plug mixture consisting of dsRNA pellet-sodium carboxymethyl cellulose powder is molded into a 5 mL syringe—with the plunger removed. The syringe containing the plug is allowed to dry (e.g., under a chemical fume hood 5 days). Advantageously, if the size of the plug were to be adjusted, (e.g., prepared in a 3 mL syringe), then proportions of ingredients would remain uniform. Upon drying for 5 days, the molded dried plug detaches from the syringe and is transferred to a sealed container (e.g., a plastic bag) with a dessicant and stored at 4° C.

A manufactured dsRNA stock solution of at least 10 mg/mL is obtained as a viscous aqueous solution. The dsRNA is concentrated from the aqueous solution by adding 1/10 volume of 3 M sodium acetate (pH 5.2) and 2 volumes of EtOH followed by pelleting down the precipitate by centrifugation at 4,000 rpm for 10 minutes. The clear EtOH/salt buffer solution is decanted from the tube leaving the intact dsRNA pellet at the bottom of the tube. Cellulose powder (1g) is mixed into the dsRNA pellet (containing at least 100 mg of dsRNA) followed by addition of 200-300 μl of the decanted EtOH/salt buffer solution until a homogenous dough mixture is obtained. This final plug mixture consisting of dsRNA pellet-cellulose powder is molded into a 5 mL syringe—with the plunger removed. The syringe containing the plug is allowed to dry (e.g., under a chemical fume hood 5 days). Upon drying for 5 days, the molded dried plug detaches from the syringe and is transferred to a sealed container (e.g., a plastic bag) with a dessicant and stored at 4° C.

While the disclosed composite pesticide plugs and methods are susceptible of embodiments in various forms, specific embodiments of the disclosure are illustrated (and will hereafter be described) with the understanding that the disclosure is intended to be illustrative, and is not intended to limit the claims to the specific embodiments descried and illustrated herein.

### Examples

The following examples illustrate the pesticide plugs and composite pesticide plugs, related methods for forming the plugs, and related methods for delivering dsRNA plant protection materials disclosed herein, but are not intended to be limiting.

The following abbreviations are used in the Examples: Al refers to active ingredient; ddPCR refers to droplet digital polymerase chain reaction; RLT refers to a lysis buffer; DFH refers to trunk diameter at one foot (about 30 cm) above ground; UTC refers to untreated control; rcf refers to relative centrifugal force; PVOH refers to polyvinyl alcohol; PVA refers to polyvinyl acetate; DAT refers to days after treatment.

dsRNA Precipitation Methods (dsRNA Concentrations of at Least 1 mg/mL):

Ethanol precipitation. To a dsRNA solution was added 0.1 volume of 3 M sodium acetate (pH 5.5) with mixing (e.g., vortex mixing). Precipitation was induced by adding 2.5 volumes of 100% EtOH. Alternatively, 5 M sodium chloride was added to the dsRNA solution to a final concentration of 0.3 M sodium chloride before precipitation with EtOH. The precipitated mixture was incubated on ice for at least 1 hour, or at least 20 minutes at −80° C. The precipitated dsRNA was pelleted by centrifugation (e.g., 4,000 rpm for 5-10 minutes) and the supernatant decanted.

Isopropanol precipitation. To the dsRNA solution was added 0.5 volume of 7.5 M ammonium acetate was added with mixing (e.g., vortex). Precipitation was induced by adding 1 volume of isopropanol followed by incubating on ice for at least 1 hour, or at least 20 minutes at −80° C. The precipitated dsRNA was pelleted by centrifugation (e.g., 4,000 rpm for 5-10 minutes) and the supernatant decanted. The pellet was rinsed with cold 70% EtOH

Non-Alcohol precipitation technique. Lithium chloride precipitation (for dsRNA solutions that may contain carbohydrate, protein or DNA). To the dsRNA solution was added 0.5 volume of 7.5 M lithium chloride followed by incubating at −20° C. for at least 30 min. The dsRNA was pelleted by centrifugation (e.g., 4,000 rpm for 5-10 minutes) and the supernatant decanted. The pellet rinsed with cold 70% EtOH.

### Cellulose-PVOH Plug

Before melt blending, the polyvinyl alcohol (PVOH; MOWIFLEX LP TC 251, Kuraray Inc., Houston, TX) and cellulose powder (Type 101, Sigma Aldrich, Milwaukee, WI) were dried at 55° C. to remove moisture. Polyvinyl alcohol and cellulose powder were weighed and mixed based on a 40:60 percent ratio per batch.

Filistruder Conditions: Processed 50 gram samples using single screw extruder with ¼″ (6.4 mm) rod die, 180° C. at die. Samples then cut to 1 inch length (25.4 mm; approximately 1 gram). Next a cordless drill and 1/16 inch (1.6 mm) drill bit (DeWalt, Towson, MD) was used to make a 2 cm deep hole into one end of each plug.

A solution of 7.5 mg/ml dsRNA in 10 ml 1× MES-buffered saline (ph=6.5; Alfa Aesar) was prepared. 1.9 ml of 100% ethanol was added to the solution to provide a final alcohol concentration of 16% (vol/vol), and 6.3 mg dsRNA/ml of final solution (equivalent to 6.3 μg dsRNA/μl solution). Next, 130 μl of final solution was slowly pipetted into the hole-end of each plug, and then allowed to air-dry for 10-15 min under a chemical fume hood. The cellulose plug containing the dsRNA was then stored in 4° C. refrigeration in a plastic bag with dessicant pouches to maintain integrity. Expected amount of bound dsRNA per 0.6 gram of cellulose powder is approx. 820 μg (equal to 0.820 mg).

### Cellulose Powder Plug

Cellulose powder (0.6 g) (Type 101, Sigma Aldrich, Milwaukee, WI) was loaded in a sterile 3 mL plastic syringe (Becton Dickinson Co. Franklin Lakes, NJ) (used as a spin-column) with the bottom surface lined with 3 layers of sterilized cotton filter paper (#41, cut to size) (Whatman, Vernon Hills, IL). The syringe plunger was discarded. The syringe rested on a 15 mL conical tube (Corning RNAse-free, Cole-Palmer, Vernon Hills II.) which collected the flow-through from each centrifugation step. A solution of 7-8 mg dsRNA in 4 mL of RNAse-free water was prepared. One mL of 5× MES-buffered saline (ph=6.5; Alfa Aesar) was added to the dsRNA solution. After mixing the dsRNA/saline solution, 1 mL of 100% ethanol was added to it to provide a final concentration of 16% (v/v). The cellulose powder in the syringe was first primed with the addition of 2 mL of 1× MES-buffered saline containing 16% (v/v) ethanol and centrifuged at 3000-4000 rpm for 2-3 min. The dsRNA-binding buffer mixture was then applied to the syringe column 2 ml at a time and centrifuged at 3000-4000 rpm for 3 min each round of binding (required 3 rounds to run the total volume of buffer). The flow-through was discarded after each centrifugation. After the binding steps, a drying spin was performed at 5000 rpm for 10 minutes. The cellulose powder with bound dsRNA was further air-dried in the syringe under a chemical fume hood for another 10 min. The syringe containing the cellulose powder with dsRNA was then stored at 4° C. in a sealed bag (e.g., ziplock bag) with dessicant pouches to maintain integrity. The amount of bound dsRNA per 0.6 gram of cellulose powder was estimated to be approximately 1.6 mg.

### Cellulose-PVA Plug

A manufactured dsRNA stock solution of at least 10 mg/mL was obtained as a viscous aqueous solution. The dsRNA was concentrated from the aqueous solution by adding 1/10 volume of 3 M sodium acetate (pH 5.2) and 2 volumes of EtOH followed by pelleting down the precipitate by centrifugation at 4,000 rpm for 10 minutes. The clear EtOH/salt buffer solution was decanted from the tube leaving the intact dsRNA pellet at the bottom of the tube. Cellulose powder (1 g) was mixed into the dsRNA pellet (containing at least 100 mg of dsRNA) followed by addition of 200-300 μl of the decanted EtOH/salt buffer solution until a homogenous dough mixture was obtained. One gram of generic school glue (polyvinyl acetate or PVA) was then incorporated/folded/mixed into the dsRNA-cellulose dough mixture. This final plug mixture consisting of dsRNA pellet-cellulose powder-polyvinylacetate was molded into a 5 mL syringe-with the plunger removed. The syringe containing the plug was allowed to dry (e.g., under a chemical fume hood 5 days). Upon drying for 5 days, the molded dried plug detached from the syringe and was transferred to a sealed container (e.g., a plastic bag) with a dessicant and stored at 4° C.

### Laboratory Dissipation Studies

For laboratory dissipation studies, plugs containing 1-20 milligram (each) of dsRNA were placed in each of three replicate 50 mL RNAse-free conical tubes, and 35 mL of nuclease-free water added to each container and closed. After each sampling interval, the solution was removed and a fresh 35 mL of water added to each sample container. An aliquot of each sample solution was analyzed using the NANODROP (ThermoFisher Scientific; Waltham, MA) spectrophotometer to determine nucleic acid concentration, and agarose gel electrophoresis was used to determine integrity of the dsRNA band (for concentrations applicable to this technique).

### Field Studies

### Field Trial 1 Methods

Field studies were initiated to determine if dsRNA can be delivered to apple tree canopy foliage, comparing three controlled-release plugs, with and without the addition of water, to a liquid formulation using a commercial trunk injection tool (e.g., ARBORJET QUICKJET). The dsRNA and dosage parameters are provided in Table 1. Treatment injections were made to semi-dwarf Yellow Delicious apple trees (6 inch or about 15 cm DFH) on 20 May (tight cluster/pink stage of apple phenology), with eight injection ports per trunk and approximately one foot (or about 30 cm) above the ground, replicated four times.

Field samples were taken from injected trees for each treatment by collecting leaves 3, 14, 35, 56, 84 days after treatment (DAT). The leaf samples were a minimum of 40 leaves (±20 g) of tissue collected from the N, S, E, W sides of the tree, high/low, and delivered in a cooler on the same day to the laboratory. Leaf samples were placed in a mortar (mortar and pestle that has been pre-chilled in −80° C. freezer), and leaves ground to a fine powder with pestle after submersing in liquid nitrogen. Label sample vials and autoclaved 2 mL sample vials were held in −80° C. freezer until filled with 1-2 g of leaf powder, two sub-samples per treatment and replicate. Sample vials were stored at −80° C. until shipping to an RNA analysis laboratory in dry ice for quantification. Recovery data was recorded and graphically displayed to compare temporal delivery patterns across treatments.

TABLE 1
Field Trial 1 Treatment

| | | Plugs | dsRNA | Application Method¹ |
|---|---|---|---|---|
| ID | Sample | (per tree) | (g/tree) | (per tree) |
| TR1 | UTC | | | |
| TR2 | QUICKJET dsRNA | | 1 | 8 ports; 400 mL |
| | liquid | | | water |
| TR3 | dsRNA cellulose- | 4 | 1 | 8 plugs, 9.5 mm |
| | PVA plug | | | dia., drill |
| TR4 | dsRNA cellulose | 4 | 1 | 8 plugs, 9.5 mm |
| | plug | | | dia., drill |

¹Each treatment has four replicates, with one tree representing one replicate.

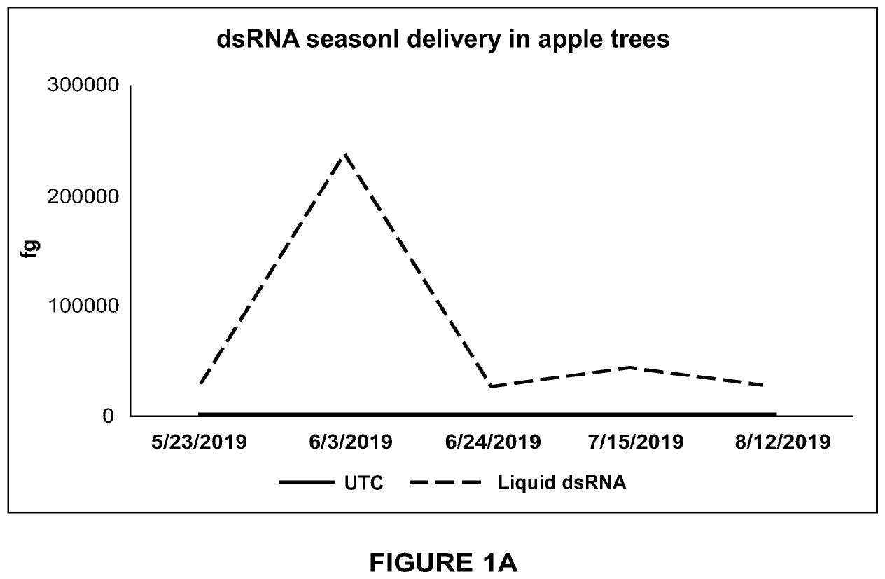

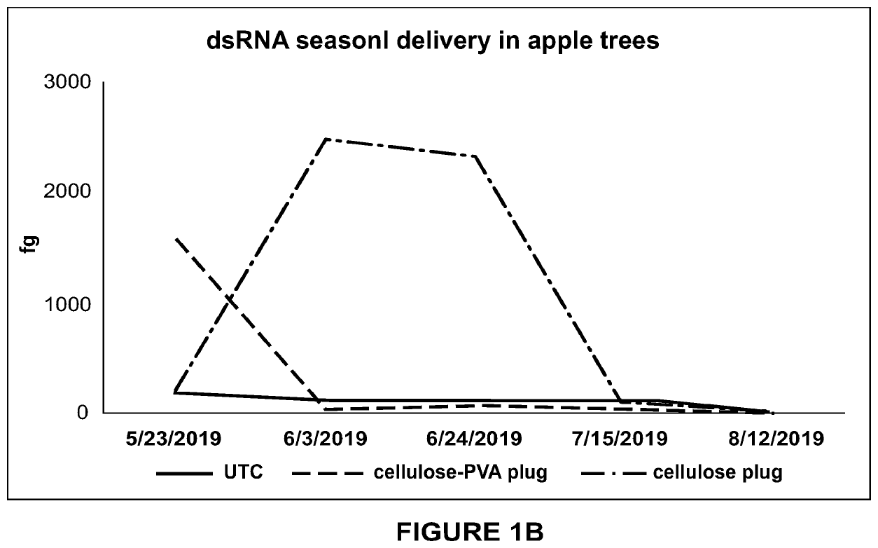

The dsRNA delivered in the tree was quantified using PCR. The results are summarized in FIGS. 1A and 1B. Polymerase chain reaction (PCR) results showed that the liquid formulation of dsRNA delivered the highest concentrations to the tree canopy, peak levels reaching approximately 250,000 fg, or 10 ng/1 g leaf tissue (average apple leaf is 0.5 g) (FIG. 1A). The dsRNA plug injections according to the disclosure resulted in lower concentrations in the canopy, peak levels reaching 2,500 fg, or 100 pg/1 g leaf tissue (FIG. 1B). Even though the plugs delivered less dsRNA to apple leaves, there was positive evidence for controlled release.Mite Bioassays

The collection of the apple leaves from the field was conducted at five different times: 3, 14, 35, 56, and 84 days after treatment (DAT). The apple leaves were put in a cooler and delivered to laboratory on the same day. Upon arrival in the laboratory, the leaves were cut into leaf discs and put into a plastic cup containing 1.5% agar (NEOGEN culture media, ACUMEDIA), and the assay was conducted on the following day.

### Leaf Disc Bioassays

Leaf disc method was used on all the assays in this study. In summary, five to ten apple leaves were collected from each replicate tree. A leaf disc (1 cm diameter) was cut from each leaf and put into a suitable container with agar (e.g., plastic cup having 4.8 cm in diameter, 2 cm high, 44 mL in volume containing 20 mL of 1.5% agar). The leaf disc was put upside down on the agar as mites usually feed on the underside of the leaves. In this instance, each plastic cup had five leaf discs placed in the middle zone of the agar in the cup and arranged in a way that they did not touch each other. Then, the agar on the peripheral zone was cut and removed, and distilled water was added to serve as a barrier. This water barrier surrounding the agar was aimed to preventing the mites from escaping or moving off the leaf discs. Then the cup was covered with its lid that was poked with insect pin to have 15 holes for aeration.

### Assays on Adult Female Mites

Adult females were collected from the mite colony. To that end, leaves were cut from the bean plants and female mites were collected with a small brush under a microscope and transferred onto the leaf discs. Females were checked after the transfer to make sure they were healthy, and injured females were replaced. Two adult females were put on each leaf disc; thus, a plastic cup with five leaf discs contains ten females. Each plastic cup represents one replicate. The plastic cups were placed on a tray and put in the insectary facility at 25° C. and 16L:8D h photoperiod. The mortality of the mites was monitored daily for five days. Mites were considered dead when they did not respond to a poke with a thin paint brush. The tests were conducted on the five leaf sampling dates (3, 15, 35, 56, and 84 DAT). Each test had four treatments (TR1, TR2, TR3, TR4). Each treatment had four replicates with 10 adult females in each.

### Assays on Early Stage of Mites

Assays were also performed on mites exposed to the treated leaves since an early stage of their development. These tests were conducted on the last four sampling dates (14, 35, 56, and 84 DAT) after no effect on adults was observed on the 3 DAT assay. The procedures of each assay were slightly different form one another depending on the objective of the tests and the health of the leaf discs. All the assays started by collecting adult females from the colony. These females were allowed to lay eggs on the apple leaf discs for 24 h or 48 h and then were removed. The cup containing the eggs on the leaf discs was held in the insectary facility (at 25° C. and 16L:8D h photoperiod). Eggs were checked daily for hatchability, which occurred three to four days after egg deposition.

### 84 DAT Assay

For the assay on 84 DAT, two adult females were collected and allowed to lay eggs on each leaf disc before being removed after 24 h. Eggs were checked daily for hatchability. Only two newly hatched larvae were allowed to grow on each disc and the remaining larvae were removed with an insect pin. Mites that hatched at the same time were selected to ensure all mites are at the same age. Mites were monitored daily until their death. To this end, leaf discs were replaced when they started to turn brown which occurred after seven to ten days. Thus, apple leaves used at the beginning of the assays were stored in the refrigerator at 4° C. These apple leaves were used to replace the corresponding leaf discs that started to decay. The two individual mites placed on the same leaf discs were separated when they become adults. The individual mite that emerged first as adult was transferred to a new leaf disc. This separation was to enable the monitoring of the longevity and fecundity of each single emerged adult female. Decayed leaf discs were replaced with discs cut from new apple leaves collected from the field one week after the beginning of the assay.

The mite survivorship was compared on days 5, 10, and 15 after egg hatching. Typically, after day 15, most of the surviving mites become adults; and the number of emerged adults, the longevity and fecundity of emerged adult females were recorded. The assays had four treatments (TR1, TR2, TR3, TR4). Each treatment contained four replicates and each replicate was started with 10 newly hatched larvae. However, the untreated TR1 has three replicates only; leaves from one of the TR1 replicates did not support the development of the mite larvae and had to be removed. Each replicate was started with 10 newly hatched larvae.

### Results and Statistical Analysis

Generalized linear models (GLM) were used to estimate the effect of treatments on mites. GLM with binomial distribution was used for the analysis of data on immature survivorship, adult mortality and adult emergence; whereas GLM with poisson distribution was performed for data on adult female longevity and fecundity. GLM with quasibinomial and negative binomial distribution was used when data are overdispersed. Multiple comparison with Tukey's test was conducted if there is a significant difference among treatments. All tests were performed using the software R (version 3.6.1).

3, 14, 35, and 56 DAT Assays: Results for adult female mite and juvenile assays indicate no difference in mite mortality or survivorship.

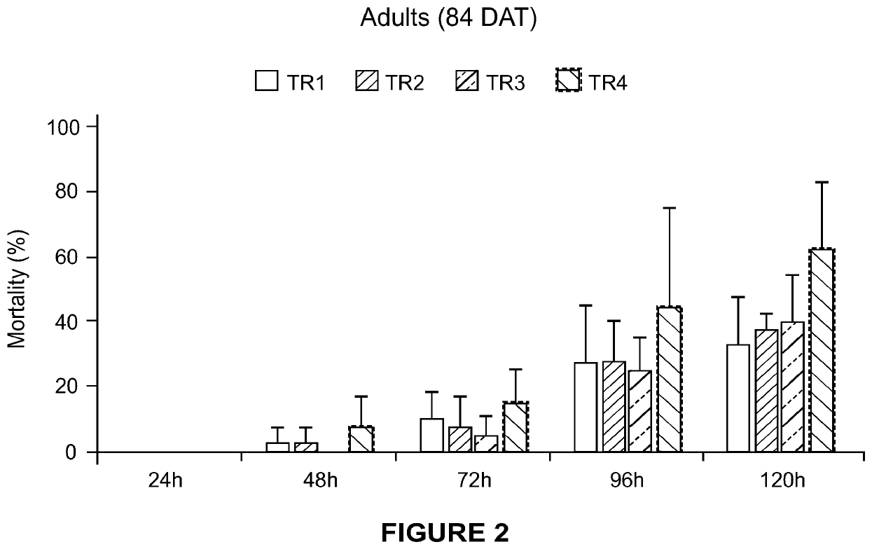

84 DAT Assays: Adult female mites were exposed for five days to the treated leaves collected 84 DAT. No difference in mortality was observed among treatments at 48, 72, and 96 h (F(3,12)=1.11, p=0.38; F(3,12)=1.00, p=0.42; F (3,12)=0.94, p=0.45, respectively) (FIG. 2). No asterisk (*) indicates no significant difference between treated and untreated mites according to Tukey's test at p<0.05.The mortality in treatment TR4 (62.5%) appeared to be higher compared to that in the untreated control TR1 (32.5%) at 120 h; however the statistical analysis indicated no difference among treatments (F(3,12)=3.2, p=0.06).

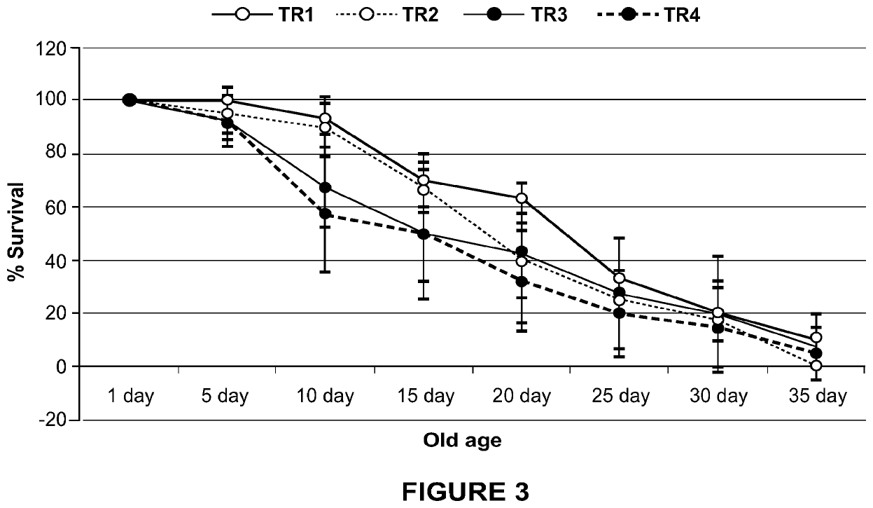

Mites were also exposed to the treated leaf discs since egg stage and the survivorship of the hatched mites was monitored until their death. Each replicate had 10 individual mites. No difference in survivorship was observed among the four treatments 5 and 15 days after egg hatching (F(3,11)=0.69, p=0.57; F(3,11)=1.45, p=0.28). In contrast, the statistical analysis indicates a significant difference among treatments after 10 days (F (3,11)=4.68, p=0.02). The follow up Tukey's test shows that the percent survival of mites in the treatment TR4 (57.5%) was significantly lower compared to that in the untreated control TR1 (93.3%) (p=0.01); a significant difference was also observed between treatment TR4 and treatment TR2 (p=0.01) (FIG. 3).

The adult emergence of these mites exposed to the treated leaves since egg stage was also studied. The mean percentage of emerged adults in treatment TR4 appeared to be lower compared to that of the untreated control (42.5% and 73.3% respectively) (Table 2), however, the data analysis indicated no statistical difference among the four treatments (F (3,12)=1.62, p=0.24). Similarly, there was no statistical difference in the longevity and fecundity of the emerged adult females among the four treatments (F (3,58)=0.87, p=0.46; (F (3,58)=1.06, p=0.36). (Table 2).

TABLE 2
Summary of adult mites emerging from individual mites exposed
since egg stage to apple leaves treated with dsRNA (84 DAT).

| | Emerged adults (84 DAT) | | |
|---|---|---|---|
| | | Mean Adult Female | |
| | % Emerged Adults | Longevity | Mean Eggs per |
| Treatment | (males and females) | (day) ± SD | Female ± SD |
| TR1 | 73.3 ± 11.5 | 12.1 ± 7.2 | 5.7 ± 3.8 |
| TR2 | 60.0 ± 25.8 | 11.3 ± 6.4 | 4.8 ± 5.3 |
| TR3 | 50.0 ± 18.3 | 13.0 ± 7.2 | 5.2 ± 4.3 |
| TR4 | 42.5 ± 17.0 | 15.3 ± 6.5 | 8.0 ± 6.1 |

No asterisk indicates no significant difference between treated and untreated mites according to Tukey's test at p < 0.05; (TR1: untreated control, TR2: dsRNA liquid, TR3: Cellulose-dsRNA-PVA plug, TR4: cellulose-dsRNA plug

### Field Trial 2 Methods

Additional field studies were conducted as previously described to determine if dsRNA can be delivered to apple tree canopy foliage, comparing three controlled-release plugs, with and without the addition of water, to a liquid formulation. The dsRNA and dosage parameters are provided in Table 3. Treatment injections were made to semi-dwarf Yellow Delicious apple trees (6 inch or about 15 cm DFH) on 18 May (tight cluster stage of apple phenology), with four injection ports per trunk and approximately one foot (or about 30 cm) above the ground, replicated four times.

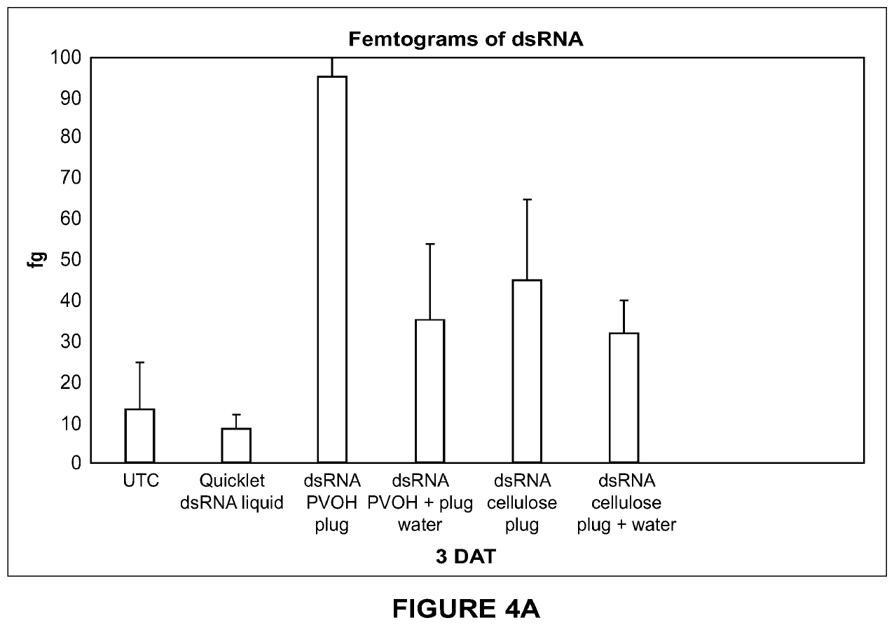

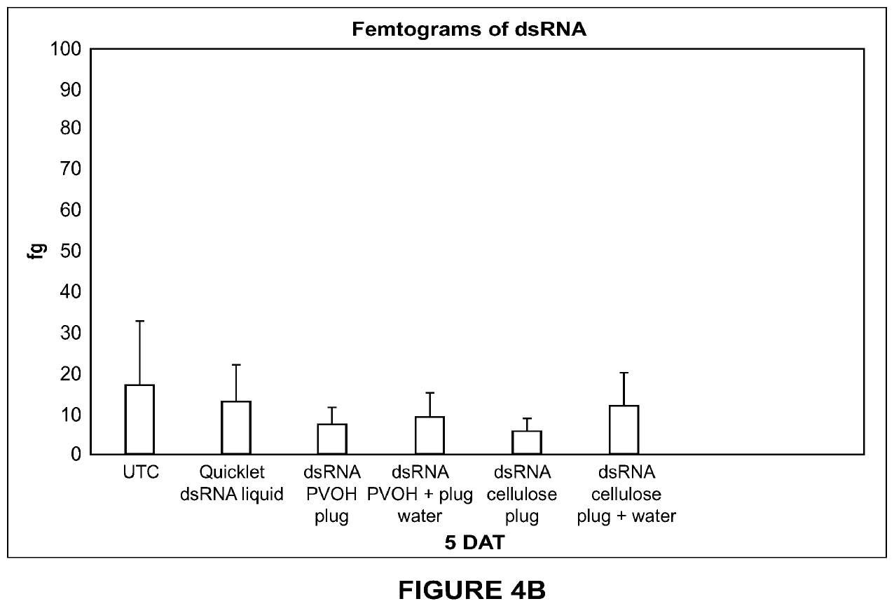

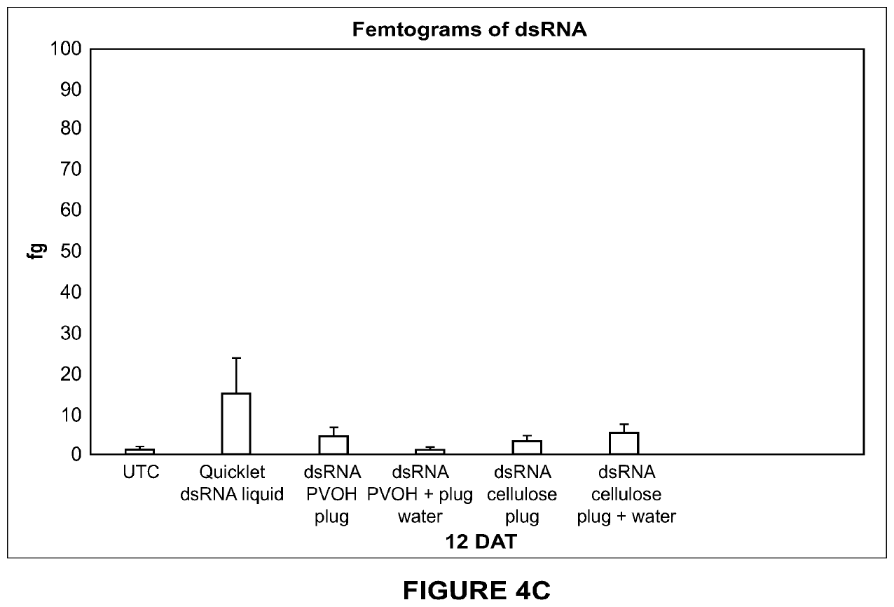

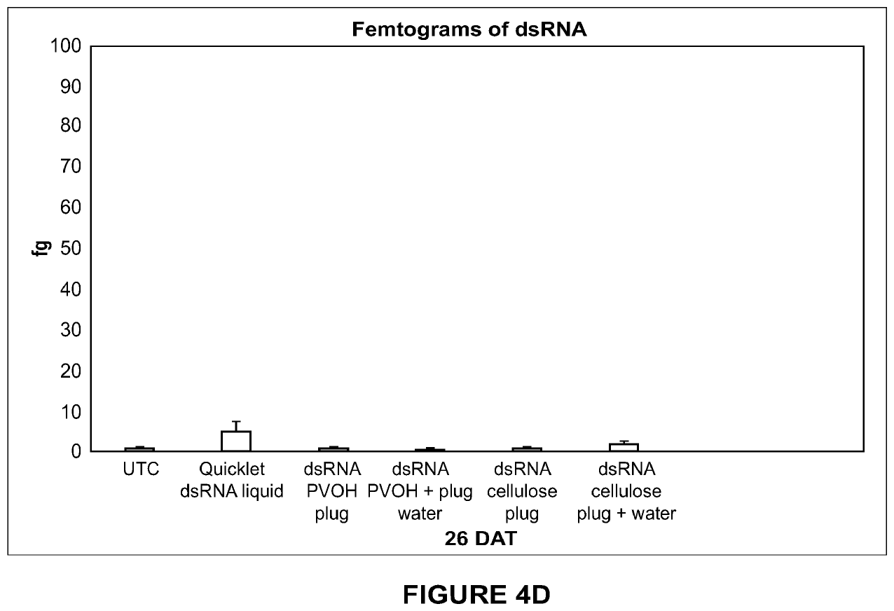

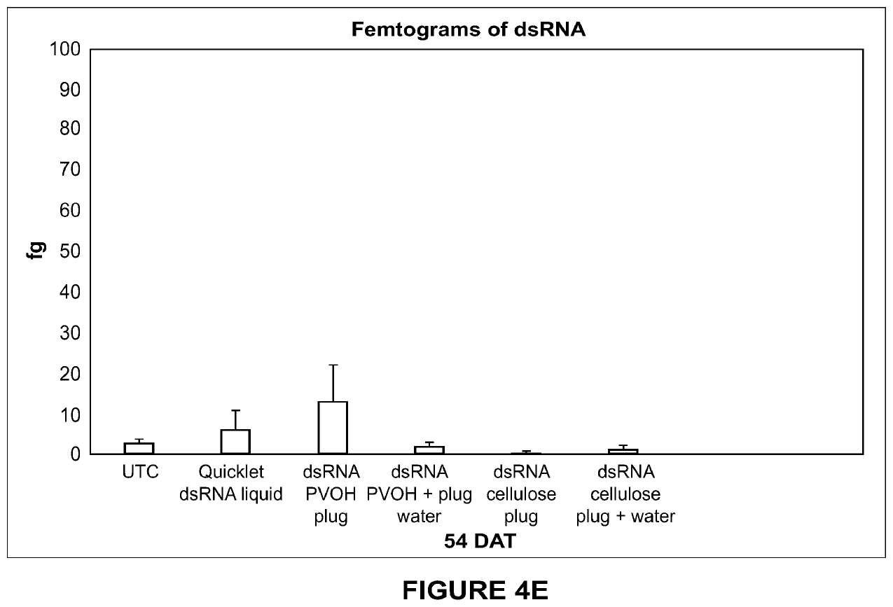

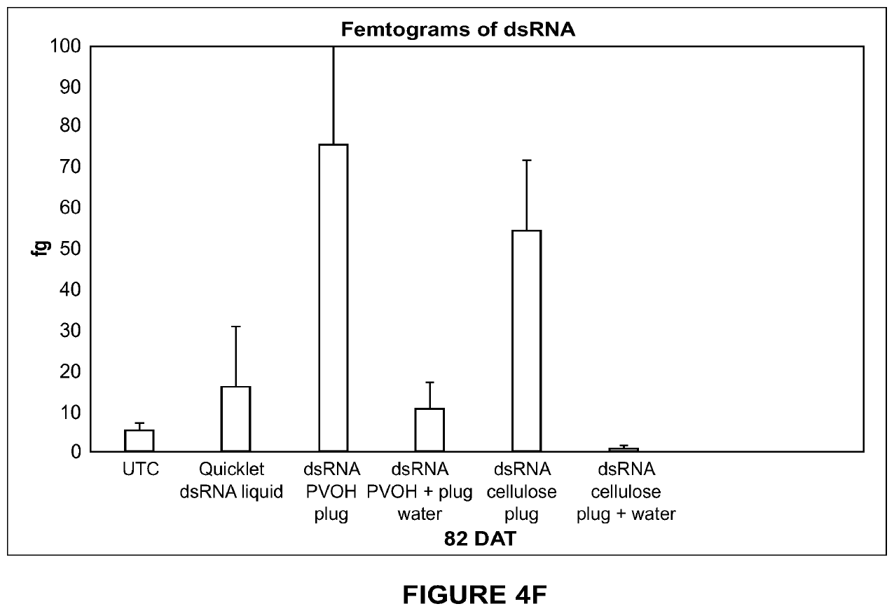

Field samples were taken from injected trees for each treatment by collecting leaves 3, 5, 12, 26, 54, 82 days after treatment (DAT). The leaf samples were a minimum of 40 leaves (±20 g) of tissue collected from the N, S, E, W sides of the tree, high/low, and delivered in a cooler on the same day to the laboratory. Leaf samples were placed in a mortar (mortar and pestle that has been pre-chilled in −80° C. freezer), and leaves ground to a fine powder with pestle after submersing in liquid nitrogen. Label sample vials and autoclaved 2 mL sample vials were held in −80° C. freezer until filled with 1-2 g of leaf powder, two sub-samples per treatment and replicate. Sample vials were stored at −80° C. until shipping to the laboratory in dry ice for quantification. Recovery data was recorded and graphically displayed to compare temporal delivery patterns across treatments (FIGS. 4A-4F).

TABLE 3
Field Trial 2 Treatment

| | | Plugs | | |
|---|---|---|---|---|
| | | (per | dsRNA | Application Method¹ |
| ID | Sample | tree) | (mg/tree) | (per tree) |
| TR1a | UTC | | | |
| TR2a | QUICKJET dsRNA | | 10 | 400 ml water |
| | liquid | | | |
| TR3a¹ | dsRNA cellulose PVOH | 4 | 3.2 | 6.4 mm dia., drill |
| | plug | | | |
| TR4a¹ | dsRNA cellulose PVOH | 4 | 3.2 | 6.4 mm dia., drill, |
| | plug | | | 100 mL water/port |
| TR5a² | dsRNA cellulose plug | 4 | 6.5 | 9.5 mm dia., drill |
| TR6a² | dsRNA cellulose plug | 4 | 6.5 | 9.5 mm dia., drill, |
| | | | | 100 mL water/port |

¹dsRNA is 60:40 cellulose:PVOH (w/w)
²dsRNA is 0.6 g cellulose powder

### Results

The plugs delivered dsRNA to the apple canopy during one or more sampling periods, with the highest concentrations detected at the 3 DAT (May 21) and 82 DAT (August 8) dates. See FIGS. 4A-4F. The decline in dsRNA concentrations from 5 DAT to 54 DAT reflect dramatic growth dilution effects during the growing season, since apple trees add approximately 5 fold leaf tissue to the canopy during this period. Thus, even though dsRNA continued to be delivered to the canopy, accumulation was not seen until terminal growth ceases in late July with high concentrations being quantified again at 82 DAT. Peak dsRNA concentrations reached mean values of nearly 100 femtograms in May and August. By normalizing these data based on the ddPCR procedures used in quantification, the concentration of dsRNA was estimated to be as high as 135 picograms per 1 gram of leaf tissue.

### Field Trial 3 Methods

Field studies were initiated to determine if dsRNA can be delivered to apple tree canopy foliage, comparing controlled-Release plugs, with and without the addition of water, to a liquid formulation using a commercial ARBORJET QUICKJET trunk injection tool. The dsRNA and dosage parameters are provided in Table 4. Treatment injections were made to semi-dwarf Yellow Delicious apple trees (6 inch or about 15 cm DFH) on 8 April (budswell apple phenology), with four injection ports per trunk and approximately 1 ft (or about 30 cm) above the ground, replicated three times.

Field samples were taken from injected trees for each treatment by collecting leaves 56, 84, 112, and 140 days after treatment (DAT). The leaf samples were a minimum of 40 leaves (±20 g) of tissue collected from the N, S, E, W sides of the tree, high/low, and delivered in a cooler on the same day to an analysis laboratory. Leaf samples were placed in a mortar (mortar and pestle that has been pre-chilled in −80° C. freezer), and leaves ground to a fine powder with pestle after submersing in liquid nitrogen. Label sample vials and autoclaved 2 mL sample vials were held in −80° C. freezer until filled with 1-2 g of leaf powder, two sub-samples per treatment and replicate. Sample vials were stored at −80° C. until shipping to a laboratory in dry ice for quantification. Recovery data was recorded and graphically displayed to compare temporal delivery patterns across treatments.

Four treatments were used in the study: the dsRNa liquid (treatment, TR2), the cellulose plug (treatment 3, TR3), the cellulose plug +water (treatment 4, TR4) and the untreated control (treatment 1, TR1). Each treatment has four replicates, with one tree representing one replicate.

TABLE 4
Field trial treatment list.

| | | Plugs | dsRNA | Application Method¹ |
|---|---|---|---|---|
| ID | Sample | (per tree) | (g/tree) | (per tree) |
| TR1 | UTC | | | |
| TR2 | QUICKJET | | 1 | 4 ports; 400 mL |
| | dsRNA liquid | | | water |
| TR3 | dsRNA cellulose plug | 4 | 1 | 4 plugs, 9.5 mm |
| | | | | dia., drill |
| TR4 | dsRNA cellulose plug | 4 | 1 | 4 plugs ^{a}, 9.5 mm |
| | | | | dia., drill |

^{a} plus 10 mL water weekly in April

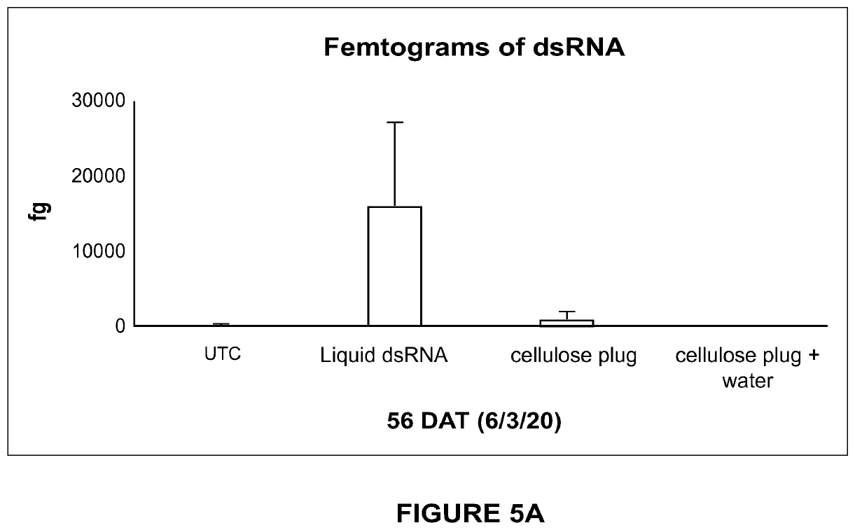

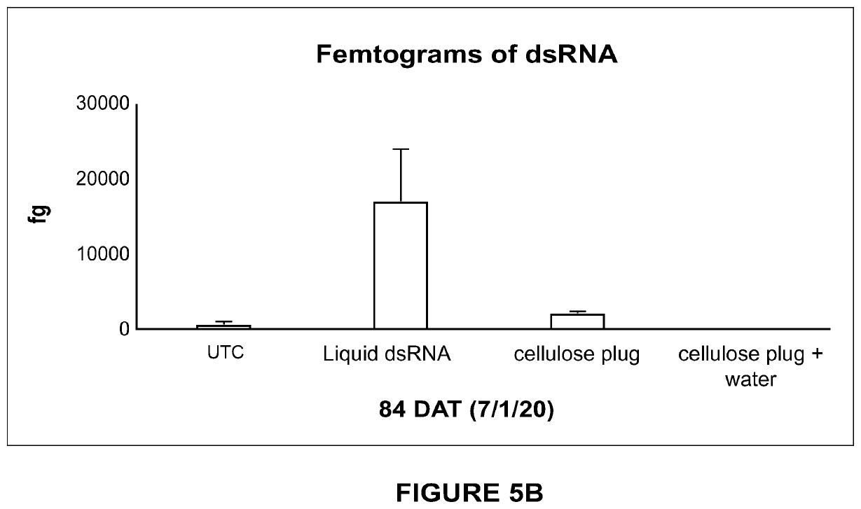

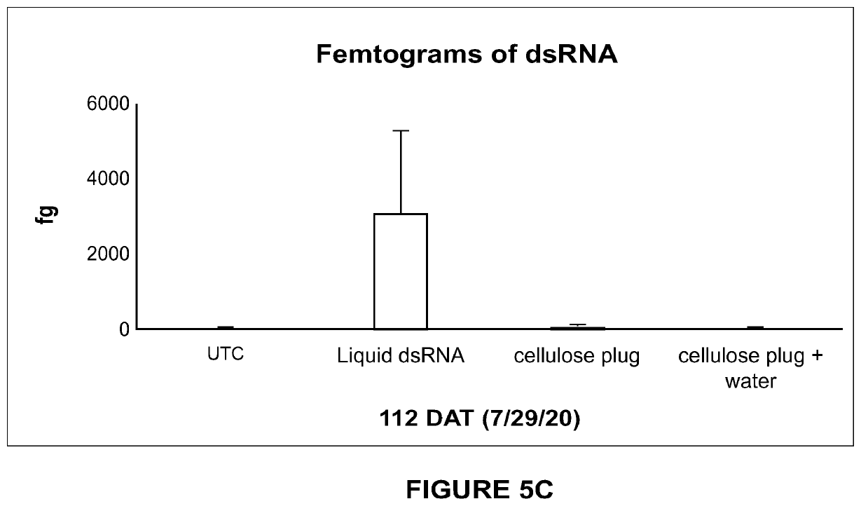

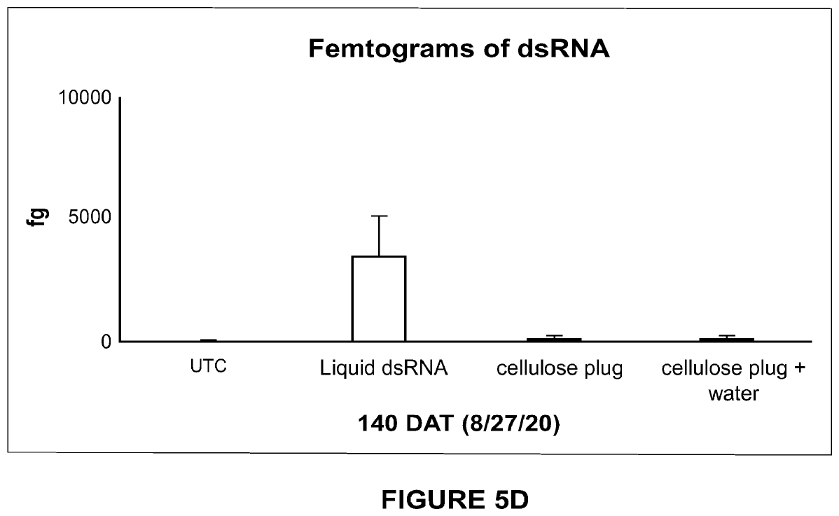

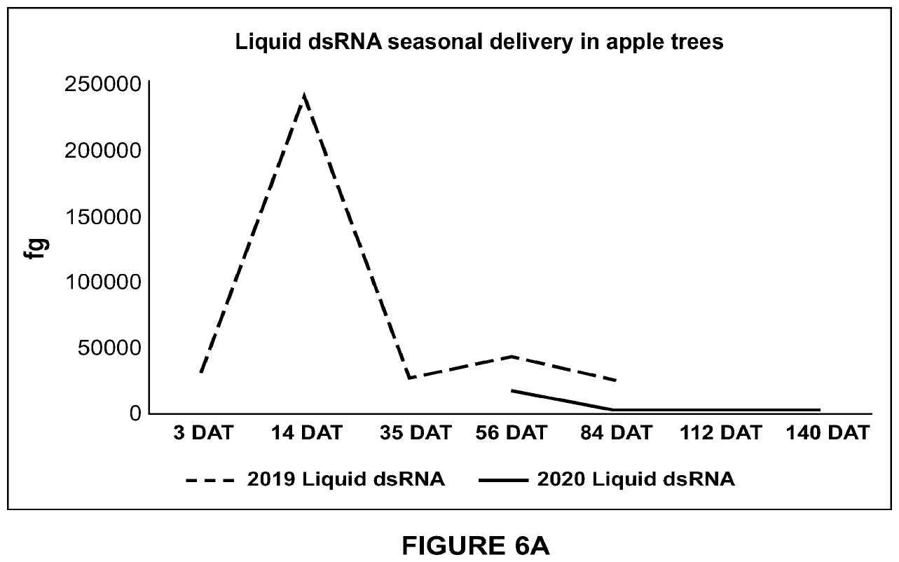

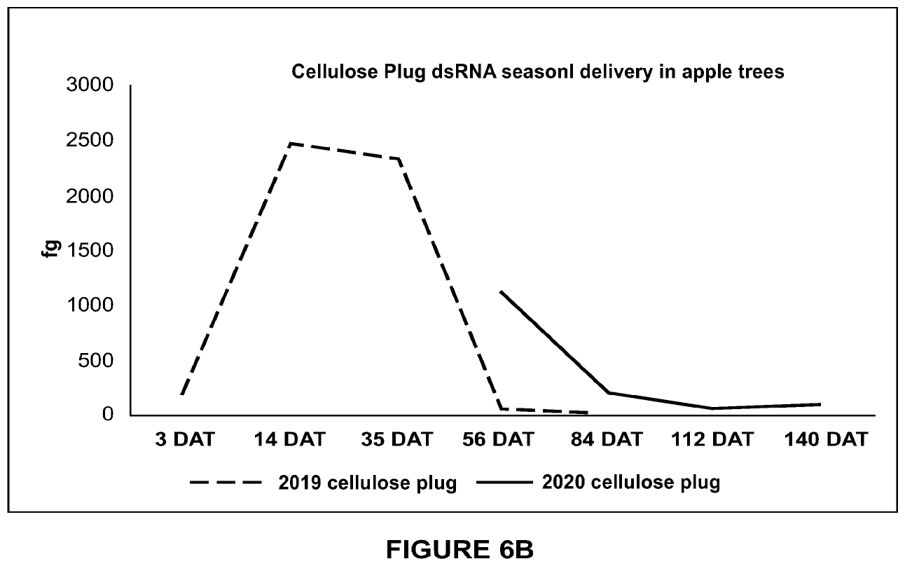

PCR results showed that the liquid formulation of dsRNA delivered the highest concentrations to the tree canopy, with peak levels reaching approximately 20,000 fg, or 0.656 ng/g leaf tissue (average apple leaf is 0.5 g). The dsRNA plug injections resulted in lower concentrations in the canopy, with peak levels reaching 1,000 fg, or 44 pg/g leaf tissue (FIGS. 5A-5D). While the plugs delivered less dsRNA to apple leaves, there was positive evidence for a longer duration of seasonal canopy delivery than the previous year's data (FIGS. 6A and 6B). In addition, injection cavities were excavated on Apr. 8, 2021 and showed very little cellulose plug material remaining. A gel was run with a 0.5 g cellulose remnant, which resulted in a strong band, indicating high integrity of the dsRNA after nearly 1 year in the tree.

Because other modifications and changes varied to fit particular operating requirements and environments will be apparent to those skilled in the art, the disclosure is not considered limited to the example(s) chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A composite pesticide plug for delivery of one or more dsRNA plant protection materials to internal tree tissue, the composite pesticide plug comprising:
(a) a cellulosic material,
(b) dsRNA (double-stranded RNA) bound to the cellulosic material, the dsRNA having a nucleotide sequence selected to target one or more target tree pests via an RNA-interference (RNAi) mechanism; and,
(c) optionally, a thermoplastic polymer matrix,
wherein, when the thermoplastic polymer matrix is present, the cellulosic material is distributed throughout the thermoplastic polymer matrix.

2. The composite pesticide plug of claim 1, wherein the cellulosic material is selected from the group consisting of cellulose powder, wood flour, wood fibers, wood chips, wood flakes, and any combination thereof.

3. The composite pesticide plug of claim 1, wherein the cellulosic material comprises cellulose powder.

4. The composite pesticide plug of claim 1, wherein the cellulosic material comprises a cellulose derivative selected from the group consisting of carboxymethyl cellulose (CMC) carboxymethyl hydroxyethylcellulose, hydroxyethyl cellulose (HEC), hydroxypropyl cellulose (HPC), hydroxypropyl methylcellulose (HPMC), hydroxyethyl methylcellulose (HPMC), ethyl hydroxyethylcellulose, methyl ethyl hydroxyethylcellulose, methyl cellulose (MC), ethyl cellulose (EC), ethyl methyl cellulose (EMC), diethylaminoethyl cellulose (DEAE-C), a salt thereof, and a combination thereof.

5. The composite pesticide plug of claim 4, wherein the cellulose derivative is carboxymethyl cellulose.

6. The composite pesticide plug of claim 5, wherein the carboxymethyl cellulose is sodium carboxymethyl cellulose.

7. The composite pesticide plug of claim 1, wherein the dsRNA targets one or more tree pests selected from the group consisting of two-spotted spider mite, (Tetranychus urticae), codling moth (Cydia pomonella (L.)), obliquebanded leafroller (Choristoneura rosaceana (Harris)), and brown marmorated stink bug (Halyomorpha halys (Stål)).

8. The composite pesticide plug of claim 1, comprising the thermoplastic polymer matrix.

9. The composite pesticide plug of claim 8, wherein the thermoplastic polymer is selected from the group consisting of polyvinyl alcohol, polylactic acid, polyvinyl acetate and combinations thereof.

10. The composite pesticide plug of claim 8, wherein the thermoplastic polymer comprises a water-soluble thermoplastic polymer.

11. The composite pesticide plug of claim 10, wherein the thermoplastic polymer comprises polyvinyl alcohol.

12. The composite plug of claim 8, wherein the thermoplastic polymer comprises a non-water soluble thermoplastic polymer.

13. The composite pesticide plug of claim 12, wherein the thermoplastic polymer comprises polyvinyl acetate.

14. The composite pesticide plug of claim 8, wherein the ratio of the cellulose to the thermoplastic polymer is about 1:4 to about 1:1.

15. The composite pesticide plug of claim 8, wherein:
the thermoplastic polymer matrix is present in an amount ranging from about 10 wt % to about 50 wt %, based on the total weight of the composite pesticide plug; and
the cellulosic material is present in an amount ranging from about 30 wt % to about 60 wt %, based on the total weight of the composite pesticide plug.

16. The composite pesticide plug of claim 1, wherein the ratio of the dsRNA to the cellulosic material is in a range of about 1:7.5×10⁵ to about 1:300.

17. The composite pesticide plug of claim 1, further comprising free dsRNA that is not bound to the cellulosic material.

18. A method for delivering a dsRNA plant protection material to a tree, the method comprising:
inserting the composite plug of claim 1 into an interior trunk region of a live tree.

19. The method of claim 18, comprising inserting the composite pesticide plug at height ranging from about 0.1 m to about 1 m above ground.

20. The method of claim 18, comprising inserting a plurality of the composite pesticide plugs distributed circumferentially around the tree trunk.

21. The method of claim 18, wherein the tree is a fruit tree selected from the group consisting of apple trees, cherry trees, grapefruit trees, lemon trees, nectarine trees, orange trees, peach trees, pear trees, plum trees, and pomegranate trees.

22. A method of preparing the composite pesticide plug of claim 8, the method comprising:
admixing the thermoplastic polymer and the cellulosic material to provide a primary composite;
forming a hole in the primary composite; and,
adding a solution comprising the dsRNA to the hole to provide the composite pesticide plug.

23. The method of claim 22, wherein admixing the thermoplastic polymer and the cellulosic material comprises melt blending the thermoplastic polymer and the cellulosic material at a temperature of about 180° C. to about 355° C.

24. The method of claim 22, wherein the thermoplastic polymer comprises polyvinyl alcohol.

25. A method of preparing the composite pesticide plug of claim 1, the method comprising:
admixing the dsRNA with the cellulosic material to provide to the composite pesticide plug.

26. The method of claim 25, further comprising admixing the dsRNA with the cellulosic material with a thermoplastic polymer.

27. The method of claim 26, wherein the thermoplastic polymer comprises polyvinyl acetate.

28. The method of claim 25, wherein the method is carried out at a temperature of about 15° C. to about 30° C.
